(19) United States
(12) Patent Application Publication
(10) Pub. No.: US 2022/0330565 A1
(43) Pub. Date: Oct. 20, 2022

(54) EDIBLE COATING WITH ANTIMICROBIAL PROPERTIES

(71) Applicant: Apeel Technology, Inc., Goleta, CA (US)

(72) Inventors: Krishnan Chari, Santa Barbara, CA (US); Stephen William Kaun, Santa Barbara, CA (US); Matthew Kahlscheuer, Goleta, CA (US); Jessica Sexton, Goleta, CA (US); Taylor Person, Goleta, CA (US)

(21) Appl. No.: 17/716,770

(22) Filed: Apr. 8, 2022

Related U.S. Application Data
(60) Provisional application No. 63/172,262, filed on Apr. 8, 2021.

(51) Int. Cl. A23B 7/154; A23B 7/16; A23L 3/3517; A23L 3/3499; A23L 3/3544; A23L 3/349; A23L 19/00

(52) U.S. Cl. CPC A23B 7/154; A23B 7/16; A23L 3/3517; A23L 3/3499; A23L 3/3544; A23L 3/349; A23L 19/05; A23V 2002/00

(57) ABSTRACT

Presented are compositions that can be used as antimicrobial coatings or protective coatings for agricultural (e.g., food) products. The compositions can comprise one or more saturated glycerides selected from monoglycerides and diglycerides; one or more surfactants; and one or more food-safe antimicrobials. The antimicrobial coatings or protective coatings can be used to prevent or delay food spoilage due to, for instance, infection by a foreign pathogen, moisture loss, or oxidation.

### CROSS-REFERENCE TO RELATED APPLICATION

This application claims the benefit of U.S. Application No. 63/172,262 entitled “EDIBLE COATING WITH ANTIMICROBIAL PROPERTIES” and filed on Apr. 8, 2021, which is incorporated herein by reference in its entirety.

### TECHNICAL FIELD

This invention relates to improving the shelf life of fresh produce, and more particularly to delaying the onset of microbial growth.

### BACKGROUND

Many common agricultural products are susceptible to degradation and decomposition, also known as spoilage, when exposed to the environment. Such degradation can occur via biotic stressors, such as bacterial, fungal, or viral infection, and/or pest infestation, or abiotic stressors, such as evaporative moisture loss from an external surface of the products to the atmosphere.

Conventional approaches to prevent degradation, maintain quality, and increase the shelf life of agricultural products include special packaging and/or refrigeration. These approaches can be expensive and may require active management. Furthermore, respiration of agricultural products is an exothermic process. Heat released during transit and storage requires active cooling of the storage space, which is a major cost driver for shipping companies.

There exists a need for new approaches to prevent degradation, reduce the generation of heat and humidity, maintain quality, and increase the shelf life of agricultural products.

### SUMMARY

Provided herein are compositions and methods for coating agricultural products in a barrier film composition. In one aspect, the composition comprises one or more saturated glycerides selected from monoglycerides and diglycerides; one or more surfactants; and one or more food-safe antimicrobials.

Embodiment 1 is a composition comprising:

one or more saturated glycerides selected from monoglycerides and diglycerides;

one or more surfactants; and

one or more food-safe antimicrobials.

Embodiment 2 is a composition of embodiment 1, wherein the composition further comprises one or more pH adjusting agents.

Embodiment 3 is the composition of embodiment 2, wherein the one or more pH adjusting agents is selected from tartaric acid, citric acid, lactic acid, maleic acid, phosphoric acid, sodium bicarbonate, or a salt thereof.

Embodiment 4 is the composition of embodiment 2, wherein the pH adjusting agent is citric acid.

Embodiment 5 is the composition of any one of embodiments 1-4, wherein the pH of the composition is lower than or equal to the pKa of the food-safe antimicrobial.

Embodiment 6 is the composition of any one of embodiments 1-5, wherein the pH of the composition is about pH 2 to about pH 6.

Embodiment 7 is the composition of any one of embodiments 1-6, wherein the pH of the composition is about pH 3 to about pH 5.

Embodiment 8 is the composition of any one of embodiments 1-7, wherein the pH of the composition is about pH 3.5 to about pH 4.5.

Embodiment 9 is the composition of any one of embodiments 1-8, wherein the one or more saturated monoglycerides has between about 10 carbons and about 20 carbons.

Embodiment 10 is the composition of any one of embodiments 1-9, wherein the one or more saturated monoglycerides has between about 14 carbons and about 18 carbons.

Embodiment 11 is the composition of any one of embodiments 1-10, wherein the one or more saturated monoglycerides has 16 carbons.

Embodiment 12 is the composition of any one of embodiments 1-8, wherein the one or more saturated monoglycerides is selected from a C10 monoglyceride, a C12 monoglyceride, a C14 monoglyceride, a C16 monoglyceride, a C18 monoglyceride, and a C20 monoglyceride.

Embodiment 13 is the composition of any one of embodiments 1-8, wherein one of the one or more saturated monoglycerides is glyceryl monostearate.

Embodiment 14 is the composition of embodiment 1, wherein the one or more surfactants are anionic, nonionic, or zwitterionic.

Embodiment 15 is the composition of embodiment 14, wherein the one or more surfactants are anionic surfactants.

Embodiment 16 is the composition of embodiment 15, wherein the one or more surfactants are fatty acids or salts thereof.

Embodiment 17 is the composition of embodiment 15, wherein the one or more anionic surfactants have a pKa that is lower than the pKa of the food-safe antimicrobial.

Embodiment 18 is the composition of any one of embodiments 1-17, wherein the food-safe antimicrobial is an organic acid antimicrobial.

Embodiment 19 is the composition of any one of embodiments 1-18, wherein the food-safe antimicrobial comprises an aromatic ring.

Embodiment 20 is the composition of any one of embodiments 1-19, wherein the one or more food-safe antimicrobials are selected from sodium benzoate, potassium sorbate, carvacrol, chalcone, fludioxonil, 2-hydroxychalcone, 4-hydroxychalcone, 4′-hydroxychalcone, 2,2′-dihydroxychalcone, 2,4′-dihydroxychalcone, 2′,4-dihydroxychalcone, 2′,4′-dihydroxychalcone, 2′,4,4′-trihydroxychalcone, 2′,4,4′-trihydroxychalcone Intermediate, violastyrene, obtusaquinone, apiole, piperine, celastrol, eugenol, arthonoic acid, leoidin, antimycin A, antimycin Al, diffractaic acid, ethyl orsellinate, methyl orsellinate, mycophenolic acid, ethyl dichloroorsellinate, angolensin, isocotoin, eupatoriochromene, xanthoxylin, usnic acid, aloin, ononetin, apocynin, isopomiferin, deoxysappanone B 7,4′-dimethyl ether, chrysin dimethyl ether, bergapten, gambogic acid, 2-hydroxyxanthone, isopimpinellin, xanthyletin, acetyl hymetochrome, nobiletin, hymechrome, methoxsalen, 4-methylesculetin, tangeritin, khellin, flavone, 3,4′,5,6,7-pentamethoxyflavone, deguelin(-), citropten, deoxysappanone B trimethyl ether, deoxysappanone B 7,3′-dimethyl ether, 2′,4′-dihydroxy-4-methoxychalcone, daunorubicin hydrochloride, plumbagin, menadione, thymoquinone, levomenthol, thymol, methyl trimethoxycinnamate, chavicol, cinnamylphenol, benzoate, napthoquinone, phenone, acetophenone, benzophenone, phenylacetophenone, chitosan, salicylic acid, and sodium salicylate.

Embodiment 21 is the composition of any one of embodiments 1-20, wherein one of the one or more food-safe antimicrobials is benzoate.

Embodiment 22 is the composition of any one of embodiments 1-21, wherein one of the one or more food-safe antimicrobials is sodium benzoate.

Embodiment 23 is the composition of any one of embodiments 1-22, wherein one of the one or more food-safe antimicrobials is chalcone.

Embodiment 24 is the composition of any one of embodiments 1-23, wherein one of the one or more food-safe antimicrobials is chitosan.

Embodiment 25 is the composition of any one of embodiments 1-24, wherein one of the one or more food-safe antimicrobials is salicylic acid.

Embodiment 26 is the composition of any one of embodiments 1-25, wherein one of the one or more food-safe antimicrobials is sodium salicylate.

Embodiment 27 is the composition of any one of embodiments 1-26, wherein one of the one or more food-safe antimicrobials is methyl salicylate.

Embodiment 28 is the composition of any one of embodiments 1-27, wherein at least one of the one or more food-safe antimicrobials is a compound of Formula (I)

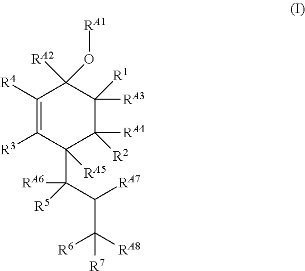

wherein:

one of the following applies:

(i) R^{A1} and R^{A2} join to form a double bond;

R^{A3} and R^{A4} join to form a double bond;

R^{A5} and R^{A6} join to form a double bond;

and R^{A7} and R^{A8} join to form a double bond; or

(ii) R^{A1} is selected from H, C₁-C₆ alkyl, and C₁-C₆ haloalkyl;

R^{A2} and R^{A3} join to form a double bond;

R^{A4} and R^{A5} join to form a double bond;
R^{A6}, R^{A7}, and R^{A8} are independently selected from H, C₁-C₆ alkyl, and halo; or any two adjacent R^{A6}, R^{A7}, or R^{A8} join to form a double bond;

R¹, R², R³, and R⁴ are independently selected from H, C₁-C₆ alkyl, hydroxyl, halo, cyano, nitro, C₁-C₆ alkoxy, —NR′R″, —C(O)NR′R″, —C(O)C₁-C₆ alkyl, —C(O)OC₁-C₆ alkyl, C₁-C₆ haloalkoxy, and C₁-C₆ haloalkyl;

R⁵, R⁶, and R⁷ are independently selected from H, C₁-C₆ alkyl, C₂-₆ alkenyl, hydroxyl, halo, C₁-C₆ alkoxy, C₁-C₆ haloalkyl, 5-10 membered heteroaryl, C₆-C₁₀ aryl, C₃-C₈ cycloalkyl, 3-10 membered heterocycloalkyl, wherein the 5-10 membered heteroaryl, C₆-C₁₀ aryl, C₃-C₈ cycloalkyl, 3-10 membered heterocyclyl are optionally substituted with one or more independently selected R^{B};

or, when (i) applies, R² and R⁶ are taken together with the atoms to which they are attached to form

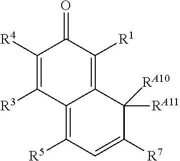

or, when (ii) applies, R^{A1} and le are taken together with the atoms to which they are attached to form a 5-6 membered heterocyclyl optionally substituted with one or more independently selected R″′;

or, when (ii) applies, R⁷ and R^{A8} are taken together with the atom to which they are attached to form

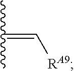

R^{A9} is selected from H or —C(O)NR′R″;

R^{A10} and R^{A11} are selected from H and C₁-C₆ alkyl,

or R^{A10} and R⁷, together with the atoms to which they are connected, join to form a C₁₄ cycloalkyl optionally substituted with one or more independently selected C₁-C₆ alkyl or C(O)OH;

each occurrence of R^{B} is independently selected from C₁-C₆ alkyl, hydroxyl, halo, cyano, nitro, C₁-C₆ alkoxy, —NR′R″, —C(O)NR′R″, —C(O)C₁-C₆ alkyl, —C(O)OC₁-C₆ alkyl, C₁-C₆ haloalkoxy, and C₁-C₆ haloalkyl;

each occurrence of R′ and R″ is independently selected from H and C₁-C₆ alkyl, or R′ and R″, together with the atom to which they are attached, join to form a 3-6 membered heterocyclyl; and

each occurrence of R″' is independently selected from H, C₁-C₆ alkyl, C₁-C₆ haloalkyl, and halo.

Embodiment 29 is the composition of embodiment 28, wherein (i) applies.

Embodiment 30 is the composition of any one of embodiments 28-29, wherein R² and R⁶ are taken together with the atoms to which they are attached to form

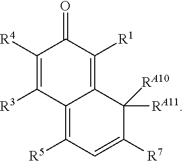

Embodiment 31 is the composition of any one of embodiments 28-30, wherein R^{A10} and R⁷, together with the atoms to which they are connected, join to form a C₁₄ cycloalkyl optionally substituted with one or more independently selected C₁-C₆ alkyl or C(O)OH.

Embodiment 32 is the composition of embodiment 28, wherein (ii) applies.

Embodiment 33 is the composition of any one of embodiments 28 and 32, wherein R^{A1} and R¹ are taken together with the atoms to which they are attached to form a 5-6 membered heterocyclyl optionally substituted with one or more independently selected R″′.

Embodiment 34 is the composition of any one of embodiments 28 and 32-33, wherein R⁷ and R^{A8} are taken together with the atom to which they are attached to form

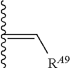

### and R^{A9} is H.

Embodiment 35 is the composition of any one of embodiments 28 and 32-34, wherein R^{A6} and R^{A7} join to form a double bond.

Embodiment 36 is the composition of any one of embodiments 28 and 32-34, wherein R^{A7} and R^{A8} join to form a double bond.

Embodiment 37 is the composition of any one of embodiments 28-29, 31-32, and 34-36, wherein R¹, R², R³, and R⁴ are independently selected from H, C₁-C₆ alkyl, hydroxyl, and C₁-C₆ alkoxy.

Embodiment 38 is the composition of any one of embodiments 28-29, 32-34, and 35-37, wherein R⁵, R⁶, and R⁷ are independently selected from H and C₆-C₁₀ aryl.

Embodiment 39 is the composition of any one of embodiments 1-27, wherein at least one of the one or more food-safe antimicrobials is a compound of Formula (II)

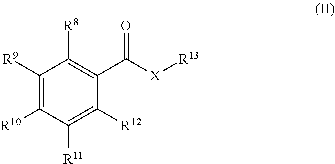

wherein:

X is selected from O and NH;

R⁸, R⁹, R¹⁰, R¹¹, and R¹² are independently selected from H, C₁-C₆ alkyl, C₂-C₆ alkenyl, C₁-C₆ alkoxy, hydroxyl, halo, -(C₁-C₆ alkyl)ₘC(O)C₁-C₆ alkyl, —NHC(O)H, —OC(O)C₆-C₁₀ aryl, wherein the C₂-C₆ alkenyl and —OC(O)C₆-C₁₀ aryl are optionally substituted with one or more independently selected R^{C};

or any two adjacent R⁸, R⁹, R¹⁰, R¹¹, and R¹² are taken together with the atoms to which they are attached to form a 5-7 membered heterocyclyl optionally fused to a C₆-C₁₀ aryl optionally substituted with one or more independently selected C₁-C₆ alkyl, halo, hydroxyl, or —C(O)OC₁-C₆ alkyl;

or R¹² and R¹³ are taken together with the atoms to which they are attached to form a 5-6 membered heterocyclyl;

R¹³ is selected from C₁-C₆ alkyl, C₆-C₁₀ aryl, 5-9 membered heterocyclyl, wherein the C₆-C₁₀ aryl and 5-9 membered heterocyclyl are optionally substituted with one or more independently selected R^{D};

each occurrence of R^{C} is independently selected from C₁-C₆ alkyl, C₁-C₆ alkoxy, and —C(O)OH;

each occurrence of R^{D} is independently selected from C₁-C₆ alkyl, C₁-C₆ alkoxy, oxo, —C(O)OH, -(C₁-C₆ alkyl)ₘC(O)C₁-C₆ alkyl, and —OC(O)C₁-C₆ alkyl; and

m is 0 or 1.

Embodiment 40 is the composition of embodiment 39, wherein R⁸, R⁹, R¹⁰, R¹¹, and R¹² are independently selected from H, C₁-C₆ alkyl, C₂-C₆ alkenyl, C₁-C₆ alkoxy, hydroxyl, and halo.

Embodiment 41 is the composition of embodiment 39, wherein any two adjacent R⁸, R⁹, R¹⁰, R¹¹, and R¹² are taken together with the atoms to which they are attached to form a 5-7 membered heterocyclyl optionally fused to a C₆-C₁₀ aryl optionally substituted with one or more independently selected C₁-C₆ alkyl, halo, hydroxyl, or —C(O)OC₁-C₆ alkyl.

Embodiment 42 is the composition of embodiment 41, wherein R¹² and R¹³ are taken together with the atoms to which they are attached to form a 5-6 membered heterocyclyl.

Embodiment 43 is the composition of any one of embodiments 39-42, wherein R¹³ is C₁-C₆ alkyl.

Embodiment 44 is the composition of any one of embodiments 1-27, wherein at least one of the one or more food-safe antimicrobials is a compound of Formula (III)

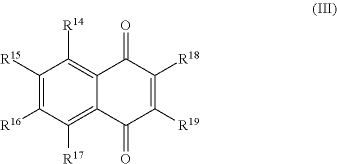

wherein:

R¹⁴, R¹⁵, R¹⁶, R¹⁷, R¹⁸ and R¹⁹ are independently selected from H, C₁-C₆ alkyl, C₁-C₆ alkoxy, hydroxyl, and halo;

or R¹⁸ and R¹⁹ are taken together with the atoms to which they are attached to form

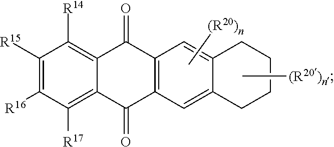

R²⁰ and R^{20′}are independently selected from hydroxyl, C₁-C₆ alkyl, halo, —C(O)C₁-C₆ alkyl, and —O-(3-8 membered heterocyclyl) optionally substituted with one or more independently selected hydroxyl, C₁-C₆ alkyl, or amino;

n is 0, 1, or 2; and

n′ is 0, 1, 2, or 3.

Embodiment 45 is the composition of embodiment 44, wherein RR¹⁴, R¹⁵, R¹⁶, R¹⁷, R¹⁸ and R¹⁹ are independently selected from H, C₁-C₆ alkyl, and hydroxyl.

Embodiment 46 is the composition of embodiment 44, wherein R¹⁸ and R¹⁹ are taken together with the atoms to which they are attached to form

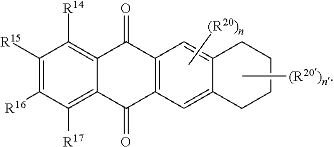

Embodiment 47 is the composition of any one of embodiments 44-46, wherein n is 2 and each R²° is hydroxyl.

Embodiment 48 is the composition of any one of embodiments 44-47, wherein n is 3 and each R²⁰′ is independently selected from hydroxyl, —C(O)C₁-C₆ alkyl, and —O—(3-8 membered heterocyclyl) optionally substituted with one or more independently selected hydroxyl, C₁-C₆ alkyl, or amino.

Embodiment 49 is the composition of any one of embodiments 1-27, wherein at least one of the one or more food-safe antimicrobials is a compound of Formula (IV)

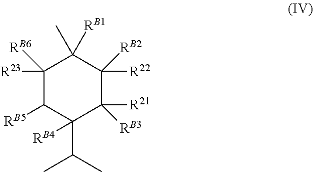

wherein:

one of the following applies:

three adjacent pairs of R^{B1},R^{B2}, R^{B3}, R^{B4}, R^{B5}, and R^{B6} join together to form double bonds; (ii) R^{B1} and R^{B2} join to form a double bond;

R^{B4} and R^{B5} join to form a double bond;

R²¹ and R^{B3} join to form an oxo; and

R²³ and R^{B6} join to form an oxo; or

(iii) R^{B1},R^{B2}, R^{B3}, R^{B4}, R^{B5}, and R^{B6} are each H;

when (i) or (iii) applies, R²¹, R²², and R²³ are independently selected from H, C₁-C₆ alkyl, C₁-C₆ alkoxy, and hydroxyl; and

when (ii) applies, R²² is selected from H, C₁-C₆ alkyl, C₁-C₆ alkoxy, and hydroxyl.

Embodiment 50 is the composition of embodiment 49, wherein (i) applies.

Embodiment 51 is the composition of embodiment 49, wherein (ii) applies.

Embodiment 52 is the composition of embodiment 49, wherein (iii) applies.

Embodiment 53 is the composition of any one of embodiments 1-27, wherein at least one of the one or more food-safe antimicrobials is a compound of Formula (V)

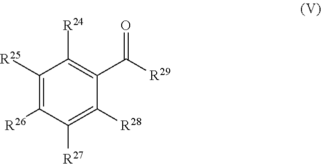

wherein:

R²⁴, R²⁵, R²⁶, R²⁷, and R²⁸ are independently selected from H, C₁-C₆ alkyl, C₁-C₆ alkoxy, and hydroxyl;

or any two adjacent R²⁴, R²⁵, R²⁶, R²⁷, and R²⁸ taken together with the atoms to which they are attached form a 5-9 membered heterocycloalkenyl optionally substituted with one or more independently selected C₁-C₆ alkyl, oxo, and —C(O)C₁-C₆ alkyl;

R²⁹ is selected from C₁-C₆ alkyl and (C₁-C₆ alkyl)ₚC₆-C₁₀ aryl, wherein the (C₁-C₆ alkyl)ₚC₆-C₁₀ aryl is optionally substituted with C₁-C₆ alkoxy;

or R²⁸ and R²⁹ taken together with the atoms to which they are attached form

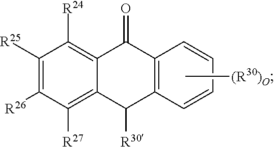

each occurrence of R³⁰ and R^{30′}is independently selected from H, C₁-C₆ alkyl optionally substituted with hydroxyl, hydroxyl, and 5-6 membered heterocyclyl optionally substituted with one or more independently selected hydroxyl or hydroxymethyl;

o is 0, 1, or 2; and

p is 0 or 1.

Embodiment 54 is the composition of embodiment 53, wherein R²⁴ and R²⁵ taken together with the atoms to which they are attached form a 5-9 membered heterocycloalkenyl optionally substituted with one or more independently selected C₁-C₆ alkyl, oxo, and —C(O)C₁-C₆ alkyl.

Embodiment 55 is the composition of any one of embodiments 53-54, wherein R²⁹ is C₁-C₆ alkyl.

Embodiment 56 is the composition of any one of embodiments 53-54, wherein R²⁹ is —(C₁-C₆ alkyl)ₚC₆-C₁₀ aryl, wherein the -(C₁-C₆ alkyl)ₚC₆-C₁₀ aryl is optionally substituted with C₁-C₆ alkoxy.

Embodiment 57 is the composition of any one of embodiments 53-54 and 56, wherein p is 0.

Embodiment 58 is the composition of any one of embodiments 53-54, and 56, wherein p is 1.

Embodiment 59 is the composition of embodiment 53, wherein R²⁸ and R²⁹ taken together with the atoms to which they are attached form

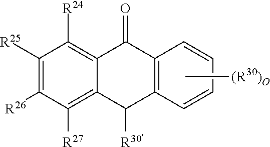

Embodiment 60 is the composition of any one of embodiments 53 and 59, wherein R³⁰ is a 5-6 membered heterocyclyl optionally substituted with one or more independently selected hydroxyl or hydroxymethyl.

Embodiment 61 is the composition of any one of embodiments 53 and 59-60, wherein o is 2 and each R^{30′}is independently selected from C₁-C₆ alkyl optionally substituted with hydroxyl and hydroxyl.

Embodiment 62 is the composition of any one of embodiments 1-27, wherein at least one of the one or more food-safe antimicrobials is a compound of Formula (VI)

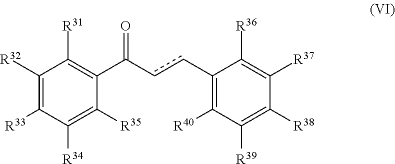

wherein:

[symbol] is a single or double bond;

R³¹, R³², R³³, R³⁴, R³⁵, R³⁶, R³⁷, R³⁸, R³⁹, and R⁴⁰ are independently selected from H, C₁-C₆ alkyl, C₁-C₆ alkoxy, halo, and hydroxyl.

Embodiment 63 is the composition of embodiment 62, wherein [symbol] is a single bond.

Embodiment 64 is the composition of embodiment 62, wherein [symbol] is a double bond.

Embodiment 65 is the composition of any one of embodiments 62-64, wherein R³², R³³, R³⁴, R³⁵, R³⁶, R³⁷, R³⁸, R³⁹, and R⁴⁰ are independently selected from H, C₁-C₆ alkyl, C₁-C₆ alkoxy, halo, and hydroxyl.

Embodiment 66 is the composition of any one of embodiments 1-27, wherein at least one of the one or more food-safe antimicrobials is a compound of Formula (VII)

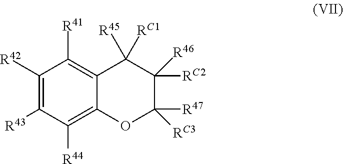

wherein:

one of the following applies:

R^{C1} and R⁴⁵ join to form an oxo; and

R^{C2} and R^{C3} are each H, or R^{C2} and R^{C3} join to form a double bond; or

(ii) RC³ and R⁴⁷ join to form an oxo; and

R^{C1} and R^{C2} are each H, or R^{C2} and R^{C3} join to form a double bond;

R⁴¹, R⁴², R⁴³, R⁴⁴, R⁴⁵, R⁴⁶, and R⁴⁷ are independently selected from H, C₁-C₆ alkyl, C₂-C₆ alkenyl, C₁-C₆ alkoxy, hydroxyl, -OC(O)C₁-C₆ alkyl, and (C₁-C₆ alkyl)_{q}C₆-C₁₀ aryl optionally substituted with one or more independently selected C₁-C₆ alkyl, C₁-C₆ alkoxy, or hydroxyl;

or one or more pairs of adjacent R⁴¹, R⁴², R⁴³, R⁴⁴, R⁴⁵, R⁴⁶, and R⁴⁷ taken together with the atoms they are attached to form one or more independently selected 5-6 membered heterocyclyl, 5-6 membered heterocycloalkenyl, C₆-C₁₀ aryl, or 5-10 membered heteroaryl, wherein the 5-6 membered heterocyclyl, 5-6 membered heterocycloalkenyl, C₆-C₁₀ aryl, and 5-10 membered heteroaryl are optionally substituted with one or more independently selected C₁-C₆ alkyl, C₁-C₆ alkoxy, or hydroxyl;

or, when (i) applies, R^{C2}, R^{C3}, R⁴⁶, and R⁴⁷ taken together with the atoms they are attached to form

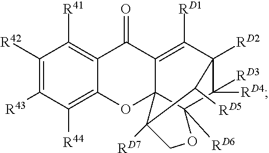

R^{D1}, R^{D2}, R^{D3}, R^{D4}, R^{D5}, R^{D6}, and R^{D7} are independently selected from H, C₁-C₆ alkyl, C₂-C₆ alkenyl optionally substituted with —C(O)OH, C₁-C₆ alkoxy, and hydroxyl,

or R^{D3} and R^{D4} join to form an oxo; and

q is 0 or 1.

Embodiment 67 is the composition of embodiment 66, wherein (i) applies.

Embodiment 68 is the composition of any one of embodiments 66-67, wherein R^{C2} and R^{C3} are each H.

Embodiment 69 is the composition of any one of embodiments 66-67, wherein R^{C2} and R^{C3} join to form a double bond.

Embodiment 70 is the composition of any one of embodiments 66-67, wherein R^{C2}, R^{C3}, R46 and R⁴⁷ taken together with the atoms they are attached to form

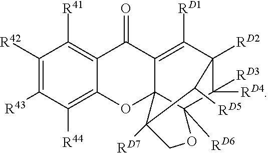

Embodiment 71 is the composition of embodiment 66, wherein (ii) applies.

Embodiment 72 is the composition of any one of embodiments 66 and 71, wherein R^{C1} and R^{C2} are each H.

Embodiment 73 is the composition of any one of embodiments 66 and 71, wherein R^{C2} and R^{C3} join to form a double bond.

Embodiment 74 is the composition of any one of embodiments 67-73, wherein R⁴¹ and R⁴² taken together with the atoms they are attached to form one or more independently selected 5-6 membered heterocyclyl, 5-6 membered heterocycloalkenyl, C₆-C₁₀ aryl, or 5-10 membered heteroaryl, wherein the 5-6 membered heterocyclyl, 5-6 membered heterocycloalkenyl, C₆-C₁₀ aryl, and 5-10 membered heteroaryl are optionally substituted with one or more independently selected C₁-C₆ alkyl, C₁-C₆ alkoxy, or hydroxyl.

Embodiment 75 is the composition of any one of embodiments 67-74, wherein R⁴³ and R⁴⁴ taken together with the atoms they are attached to form one or more independently selected 5-6 membered heterocyclyl, 5-6 membered heterocycloalkenyl,

C₆-C₁₀ aryl, or 5-10 membered heteroaryl, wherein the 5-6 membered heterocyclyl, 5-6 membered heterocycloalkenyl, C₆-C₁₀ aryl, and 5-10 membered heteroaryl are optionally substituted with one or more independently selected C₁-C₆ alkyl, C₁-C₆ alkoxy, or hydroxyl.

Embodiment 76 is the composition of any one of embodiments 1-27, wherein at least one of the one or more food-safe antimicrobials is a compound of Formula (VIII)

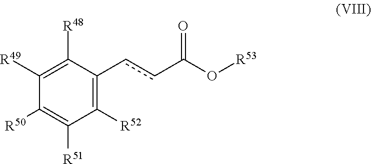

wherein:

[symbol] is a single or double bond;

R⁴⁸, R⁴⁹, R⁵⁰, R⁵¹, and R⁵² are independently selected from H, C₁-C₆ alkyl, C₁-C₆ alkoxy, halo, and hydroxyl; and

R⁵³ is selected from H, C₁-C₆ alkyl, and C₁-C₆ haloalkyl.

Embodiment 77 is the composition of embodiment 76, wherein [symbol] is a single bond.

Embodiment 78 is the composition of embodiment 76, wherein [symbol] is a double bond.

Embodiment 79 is the composition of any one of embodiments 76-78, wherein R⁴⁸, R⁴⁹, R⁵⁰, R⁵¹, and R⁵² are independently selected from H and C₁-C₆ alkoxy.

Embodiment 80 is the composition of any one of embodiments 76-79, wherein R⁵³ is C₁-C₆ alkyl.

Embodiment 81 is the composition of any one of embodiments 1-80, wherein the composition comprises about 50% to about 99% by weight of the one or more saturated glycerides.

Embodiment 82 is the composition of any one of embodiments 1-81, wherein the composition comprises about 55% by weight to about 75% by weight of the one or more saturated glycerides.

Embodiment 83 is the composition of any one of embodiments 1-82, wherein the composition comprises about 60% by weight to about 70% by weight of the one or more saturated glycerides.

Embodiment 84 is the composition of any one of embodiments 1-83, wherein the composition comprises about 63% by weight of the one or more saturated glycerides.

Embodiment 85 is the composition of any one of embodiments 1-84, wherein the composition comprises about 1% to about 10% by weight of the one or more surfactants.

Embodiment 86 is the composition of any one of embodiments 1-85, wherein the composition comprises about 3% to about 7% by weight of the one or more surfactants.

Embodiment 87 is the composition of any one of embodiments 1-86, wherein the composition comprises about 5% by weight of the one or more surfactants.

Embodiment 88 is the composition of any one of embodiments 1-87, wherein the composition comprises about 1% to about 50% by weight of the one or more antimicrobials.

Embodiment 89 is the composition of any one of embodiments 1-88, wherein the composition comprises about 3% to about 35% by weight of the one or more antimicrobials.

Embodiment 90 is the composition of any one of embodiments 1-89, wherein the composition comprises about 10% by weight of the one or more antimicrobials.

Embodiment 91 is a method of improving the shelf life of an agricultural product, the method comprising coating the agricultural product with the composition of any one of embodiments 1-90.

Embodiment 92 is a method of delaying the onset of microbial growth, the method comprising coating a produce with any one of the compositions of embodiments 1-90.

Embodiment 93 is the method of preventing produce desiccation, the method comprising coating a produce with any one of the compositions of embodiments 1-90.

Embodiment 94 is the method of embodiment 93, wherein desiccation is measured with mass loss.

Embodiment 95 is a method of improving the shelf life of an agricultural product, the method comprising:

coating the agricultural product with a composition, wherein the composition comprises:
one or more saturated glycerides selected from monoglycerides and diglycerides;
one or more surfactants; and
one or more food-safe antimicrobials.

Embodiment 96 is a method of embodiment 95, wherein one of the one or more food-safe antimicrobials is a benzoate salt.

Embodiment 97 is a method of embodiment 95, wherein one of the one or more food-safe antimicrobials is chalcone, chitosan, salicyclic acid, sodium salicylate, or methyl salicylate.

Embodiment 98 is a method of any one of embodiments 95-97, wherein the one or more saturated monoglycerides has between about 10 carbons and about 20 carbons, or has between about 14 carbons and about 18 carbons

Embodiment 99 is a method of embodiment 98, wherein one of the one or more saturated monoglycerides is glyceryl monostearate.

Embodiment 100 is a method of any one of embodiments 95-99, wherein the composition further comprises one or more pH adjusting agents.

Embodiment 101 is coated agricultural product comprising:

an agricultural product; and

an exogenous coating on a surface of the agricultural product, wherein the coating is formed from a composition comprising:
one or more saturated glycerides selected from monoglycerides and diglycerides;
one or more surfactants; and
one or more food-safe antimicrobials.

Embodiment 102 is the coated agricultural product of embodiment 101, wherein one of the one or more food-safe antimicrobials is a benzoate salt.

Embodiment 103 is the coated agricultural product of embodiment 101, wherein one of the one or more food-safe antimicrobials is chalcone, chitosan, salicyclic acid, sodium salicylate, or methyl salicylate.

Embodiment 104 is the coated agricultural product of any one of embodiments 101-103, wherein the one or more saturated monoglycerides has between about 10 carbons and about 20 carbons, or has between about 14 carbons and about 18 carbons

Embodiment 105 is the coated agricultural product of embodiment 104, wherein one of the one or more saturated monoglycerides is glyceryl monostearate.

Embodiment 106 is the coated agricultural product of any one of embodiments 101-105, wherein the composition further comprises one or more pH adjusting agents.

Various embodiments of the features of this disclosure are described herein. However, it should be understood that such embodiments are provided merely by way of example, and numerous variations, changes, and substitutions can occur to those skilled in the art without departing from the scope of this disclosure. It should also be understood that various alternatives to the specific embodiments described herein are also within the scope of this disclosure.

### BRIEF DESCRIPTION OF DRAWINGS

The following drawings illustrate certain embodiments of the features and advantages of this disclosure. These embodiments are not intended to limit the scope of the appended claims in any manner.

FIG. 1 is a plot of the normalized disease index of Mandarin oranges four days after exposure to various treatment conditions. Disease index is normalized to the control treatment. GMS is glycerol monostearate.

FIG. 2 is a plot of the mass loss factor of avocados after exposure to various treatments. ‘Mixture’ is a mixture of 94% glycerol monostearate and 6% sodium lauryl sulfate; ‘CA’ is citric acid; and ‘NaBenz’ is sodium benzoate.

FIG. 3. is a plot of stem end rot percent disease indices of avocados after various treatments. ‘MeSA’ is methyl salicylate.

FIG. 4. is a plot of stem end rot percent disease indices of avocados after various treatments.

FIG. 5. is a plot of stem end rot percent disease indices of avocados after various treatments.

FIG. 6A is a plot of CO₂ production by avocados after various treatments. ‘Mixture’ is a mixture of 94% glycerol monostearate and 6% sodium stearate; ‘SA’ is salicylic acid.

FIG. 6B is a plot of mass loss factors of avocados after various treatments. ‘Mixture’ is a mixture of 94% glycerol monostearate and 6% sodium stearate; ‘SA’ is salicylic acid.

FIG. 6C is a plot of stem end rot disease incidence and severity of avocados after various treatments. ‘Mixture’ is a mixture of 94% glycerol monostearate and 6% sodium stearate; ‘SA’ is salicylic acid.

FIG. 7 is a plot of stem end rot percent disease indices of avocados after various treatments. ‘SA’ is salicylic acid.

FIG. 8A is a plot of CO2 production by avocados after various treatments. ‘Mixture’ is a mixture of 94% glycerol monostearate and 6% sodium stearate; ‘SA’ is salicylic acid.

FIG. 8B is a plot of mass loss factors of avocados after various treatments. ‘Mixture’ is a mixture of 94% glycerol monostearate and 6% sodium stearate; ‘SA’ is salicylic acid.

FIG. 8C is a plot of stem end rot disease incidence and severity of avocados after various treatments. ‘Mixture’ is a mixture of 94% glycerol monostearate and 6% sodium stearate; ‘SA’ is salicylic acid.

FIG. 9 is a plot of stem end rot percent disease indices of avocados after various treatments. ‘Mixture’ is a mixture of 94% glycerol monostearate and 6% sodium stearate; ‘SA’ is salicylic acid.

FIG. 10A is a plot of the percent of avocados of different qualities.

FIG. 10B is a plot of the percent incidence of stem rot after various treatments and cut date of avocados. ‘Mixture’ is a mixture of 94% glycerol monostearate and 6% sodium stearate; ‘SA’ is salicylic acid.

FIG. 11A is a plot of the viscosity of salicylic acid and solutions.

FIG. 11B is a plot of the pH of salicylic acid and solutions.

FIG. 12A is a plot of the viscosity of MeSA (methyl salicylate) and solutions.

FIG. 12B is a plot of the pH of MeSA (methyl salicylate) and solutions.

FIG. 13A is a plot of the respiration factor (CO₂ production) of avocados in various treatments. ‘Mixture’ is a mixture of 94% glycerol monostearate and 6% sodium stearate.

FIG. 13B is a plot of the mass loss factor of avocados in various treatments. ‘Mixture’ is a mixture of 94% glycerol monostearate and 6% sodium stearate.

FIG. 13C is a plot of the disease incidence of avocados exposed to various treatments. ‘Mixture’ is a mixture of 94% glycerol monostearate and 6% sodium stearate.

FIG. 14 is a plot of the cut date and percentage spoiled of avocados over time when exposed to various treatments. ‘Mixture’ is a mixture of 94% glycerol monostearate and 6% sodium stearate; ‘EtOH’ is ethanol.

FIG. 15A is a plot of mass loss of lemons exposed to various treatments.

FIG. 15B is a plot of disease incidence of over time of lemons exposed to various treatments.

FIG. 16A is a plot of the mass loss factors of lemons exposed to various treatments.

FIG. 16B depicts skin burns caused by carvacrol on lemons.

FIG. 17 is a plot of mass loss factors of lemons exposed to various treatments. ‘Mixture’ is a mixture of 94% glycerol monostearate and 6% sodium stearate.

### DETAILED DESCRIPTION

### Definitions

All publications, patents, patent applications, and information available on the internet and mentioned in this specification are herein incorporated by reference to the same extent as if each individual publication, patent, patent application, or item of information was specifically and individually indicated to be incorporated by reference. To the extent publications, patents, patent applications, and items of information incorporated by reference contradict the disclosure contained in the specification, the specification is intended to supersede and/or take precedence over any such contradictory material.

Where values are described in terms of ranges, it should be understood that the description includes the disclosure of all possible sub-ranges within such ranges, as well as specific numerical values that fall within such ranges irrespective of whether a specific numerical value or specific sub-range is expressly stated.

As used herein, the term “pH adjusting agent” refers to a compound that affects the pH of the composition.

As used herein, the term “surfactant” refers to a compound that, when added to a solvent, suspension, colloid, or solution, reduces the difference in surface energy between the solvent/suspension/colloid/solution and a solid surface on which the solvent/suspension/colloid/solution is disposed.

As used herein, the term “antimicrobial” refers to a compound that inhibits growth of microorganisms, including inhibiting growth of bacteria, fungi, and viruses.

As used herein, “fatty acid” is a hydrocarbon chain comprising an ester, acid, or carboxylate group, collectively referred to as “oxycarbonyl moieties”, bonded to one terminus of the hydrocarbon chain, understood to be the “hydrophilic” end; while the opposite terminus is understood to be the “hydrophobic” end. Fatty acids include fatty acids, fatty acid esters (e.g., monoglycerides, diglycerides), and fatty acid salts. As used herein, the term “glyceride” refers to an ester formed from a glycerol and at least one fatty acid, and is a fatty acid derivative.

As used herein, the term “halo” refers to fluoro (F), chloro (Cl), bromo (Br), or iodo (I).

As used herein, the term “alkyl” refers to saturated linear or branched-chain monovalent hydrocarbon radicals, containing the indicated number of carbon atoms. For example, “C1-6 alkyl” refers to saturated linear or branched-chain monovalent hydrocarbon radicals of one to six carbon atoms. Non-limiting examples of alkyl include methyl, ethyl, 1-propyl, isopropyl, 1-butyl, isobutyl, sec-butyl, tert-butyl, 2-methyl-2-propyl, pentyl, neopentyl, and hexyl. The term “saturated” as used in this context means only single bonds present between constituent carbon atoms and other available valences occupied by hydrogen and/or other substituents as defined herein.

As used herein, the term “alkenyl” refers to a linear or branched mono-unsaturated hydrocarbon chain, containing the indicated number of carbon atoms. For example, “C2-6 alkenyl” refers a linear or branched mono unsaturated hydrocarbon chain of two to six carbon atoms. Alkenyl groups can either be unsubstituted or substituted with one or more substituents. Non-limiting examples of alkenyl include ethenyl, propenyl, butenyl, or pentenyl.

As used herein, the term “alkoxy” refers to an —O-alkyl radical, wherein the radical is on the oxygen atom. For example, “C₁₋₆ alkoxy” refers to an —O—(C₁₋₆ alkyl) radical, wherein the radical is on the oxygen atom. Examples of alkoxy include methoxy, ethoxy, propoxy, isopropoxy, butoxy and tert-butoxy.

As used herein, the term “cycloalkyl” refers to a saturated or partially saturated cyclic hydrocarbon, containing the indicated number of carbon atoms. For example, “C₃-C₆ cycloalkyl” refers to a saturated or partially saturated cyclic hydrocarbon having three to six ring carbon atoms. Cycloalkyl groups can have 3 to 20 ring carbons, preferably 3 to 16 ring carbons, and more preferably 3 to 12 ring carbons or 3-10 ring carbons or 3-6 ring carbons, wherein the cycloalkyl group may be optionally substituted. Non-limiting examples of cycloalkyl include cyclopropyl, cyclobutyl, cyclopentyl, and cyclohexyl. Cycloalkyl may include multiple fused and/or bridged rings. The term “saturated” as used in this context means only single bonds present between constituent carbon atoms.

As used herein, the term “haloalkyl” refers to an alkyl, in which one or more hydrogen atoms is/are replaced with an independently selected halo. As used herein, the term “heteroaryl”, as used herein, means a mono-, bi-, tri- or polycyclic group having 5 to 20 ring atoms, alternatively 5, 6, 9, 10, or 14 ring atoms; wherein at least one ring in the system contains one or more heteroatoms independently selected from N, O, and S and at least one ring in the system is aromatic (but does not have to be a ring which contains a heteroatom, e.g. tetrahydroisoquinolinyl, e.g., tetrahydroquinolinyl). Heteroaryl groups can either be unsubstituted or substituted with one or more substituents.

As used herein, the term “heterocyclyl” refers to a mono-, bi-, tri-, or polycyclic saturated ring system with 3-16 ring atoms (e.g., 5-8 membered monocyclic, 8-12 membered bicyclic, or 11-14 membered tricyclic ring system) having 1-3 heteroatoms if monocyclic, 1-6 heteroatoms if bicyclic, or 1-9 heteroatoms if tricyclic or polycyclic, said heteroatoms selected from O, N, or S (e.g., carbon atoms and 1-3, 1-6, or 1-9 heteroatoms of N, O, or S if monocyclic, bicyclic, or tricyclic, respectively), wherein 0, 1, 2 or 3 atoms of each ring may be substituted by a substituent. Examples of heterocyclyl groups include piperazinyl, pyrrolidinyl, dioxanyl, morpholinyl, tetrahydrofuranyl, and the like. Heterocyclyl may include multiple fused and bridged rings. The term “saturated” as used in this context means only single bonds present between constituent ring atoms and other available valences occupied by hydrogen and/or other substituents as defined herein.

The term “heterocycloalkenyl” as used herein means partially unsaturated cyclic ring system with 3-16 ring atoms (e.g., 5-8 membered monocyclic, 8-12 membered bicyclic, or 11-14 membered tricyclic ring system) having 1-3 heteroatoms if monocyclic, 1-6 heteroatoms if bicyclic, or 1-9 heteroatoms if tricyclic or polycyclic, said heteroatoms selected from O, N, or S (e.g., carbon atoms and 1-3, 1-6, or 1-9 heteroatoms of N, O, or S if monocyclic, bicyclic, or tricyclic, respectively), wherein 0, 1, 2 or 3 atoms of each ring may be substituted by a substituent. Examples of heterocycloalkenyl groups include, without limitation, tetrahydropyridyl, dihydropyrazinyl, dihydropyridyl, dihydropyrrolyl, dihydrofuranyl, dihydrothihenyl. As partially unsaturated cyclic groups, heterocycloalkenyl groups may have any degree of unsaturation provided that one or more double bonds is present in the ring, none of the rings in the ring system are aromatic, and the heterocycloalkenyl group is not fully saturated overall. Heterocycloalkenyl may include multiple fused and/or bridged and/or spirocyclic rings.

As used herein, examples of aromatic rings include: benzene, pyridine, pyrimidine, pyrazine, pyridazine, pyridone, pyrrole, pyrazole, oxazole, thioazole, isoxazole, isothiazole, and the like.

As used herein, when a ring is described as being “partially unsaturated”, it means said ring has one or more additional degrees of unsaturation (in addition to the degree of unsaturation attributed to the ring itself; e.g., one or more double or triple bonds between constituent ring atoms), provided that the ring is not aromatic. Examples of such rings include: cyclopentene, cyclohexene, cycloheptene, dihydropyridine, tetrahydropyridine, dihydropyrrole, dihydrofuran, dihydrothiophene, and the like.

For the avoidance of doubt, and unless otherwise specified, for rings and cyclic groups (e.g., aryl, heteroaryl, heterocyclyl, heterocycloalkenyl, cycloalkenyl, cycloalkyl, and the like described herein) containing a sufficient number of ring atoms to form bicyclic or higher order ring systems (e.g., tricyclic, polycyclic ring systems), it is understood that such rings and cyclic groups encompass those having fused rings, including those in which the points of fusion are located (i) on adjacent ring atoms (e.g., [x.x.0] ring systems, in which 0 represents a zero atom bridge

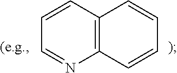

(ii) a single ring atom (spiro-fused ring systems)

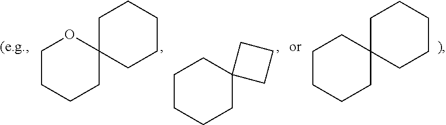

or (iii) a contiguous array of ring atoms (bridged ring systems having all bridge lengths >0)

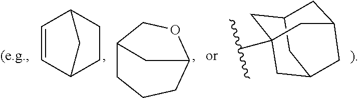

The term “mass loss rate” refers to the rate at which the product loses mass (e.g. by releasing water and other volatile compounds). The mass loss rate is typically expressed as a percentage of the original mass per unit time (e.g. percent per day).

The term “mass loss factor” refers to the ratio of the average mass loss rate of uncoated produce (measured for a control group) to the average mass loss rate of the corresponding tested produce (e.g., coated produce) over a given time. Hence a larger mass loss factor for a coated produce corresponds to a greater reduction in average mass loss rate for the coated produce.

The term “% by weight” or “percent by weight” refers to the percentage the identified components or components represent with the percent calculated as percent by weight of all components excluding water, unless otherwise noted.

The term “each,” when used in reference to a collection of items, is intended to identify an individual item in the collection but does not necessarily refer to every item in the collection, unless expressly stated otherwise.

### Composition Embodiments

Edible barrier coatings on agricultural products can, for example, prevent water loss from the products, oxidation of the products, and/or can shield the products from threats such as fungi, bacteria, viruses, and the like. Antimicrobials can be used in barrier coatings, but some, such as organic acid antimicrobials, require a specific pH range, such as an acid pH, for maximum efficacy. Some barrier coatings have a relatively high pH (about 9.5), which decreases the efficacy of the antimicrobials that are most efficacious in an acidic pH range. Altering compositions to better inhibit microbial growth while limiting water loss would be beneficial. It can be challenging to find compatible solutions that both inhibit microbial growth while limiting water loss from the agricultural product.

Described herein are compositions, for example, edible barrier coatings, that can be used to improve the shelf life of agricultural products, for example, by preventing or delaying the onset of microbial growth. In some embodiments, the compositions comprise a) one or more saturated glycerides, b) one or more surfactants, and c) one or more food-safe antimicrobials.

In some embodiments, the compositions further comprise one or more pH adjusting agents. In some embodiments, the pH adjusting agent is an acid. The pH adjusting agent can include, for example, citric acid, acetic acid, hydrochloric acid, sulfuric acid, phosphoric acid, hydrobromic acid, ascorbic acid, tartaric acid, formic acid, gluconic acid, lactic acid, oxalic acid, boric acid, malic acid, uric acid, sodium bicarbonate or a combination thereof. In some embodiments, the pH adjusting agent is citric acid. In some embodiments, pH adjusting agents can, for example, alter the pH of the composition such that the antimicrobial has a high efficacy.

In some embodiments, the pH of the composition is adjusted to a value lower than or equal to the pKa of the food-safe antimicrobial. In some embodiments, the pH of the composition is in the range of about pH 2 to about pH 6, about pH 4 to about pH 6, about pH 2 to about pH 4.

In some embodiments, the saturated glycerides are one or more saturated monoglycerides, one or more saturated diglycerides, one or more saturated triglycerides, or combinations thereof. In some embodiments, the saturated glycerides are one or more saturated monoglycerides. In some embodiments, the one or more saturated monoglycerides have a range of about 10 carbons and about 20 carbons, between about 12 carbons and about 20 carbons, between about 14 carbons and about 18 carbons, or between about 16 carbons and about 20 carbons. In some embodiments, the one or more saturated monoglycerides has 16 carbons. In some embodiments, the one or more saturated monoglycerides is a C10 monoglyceride, a C12 monoglyceride, a C14 monoglyceride, a C16 monoglyceride, a C18 monoglyceride, or a C20 monoglyceride. In some embodiments, the one or more saturated monoglycerides are a 1-monoacylglyceride, a 2-monoacylglyceride, monolaurin, glyceryl monostearate, glyceryl monooleate, or glyceryl hydroxystearate. In some embodiments, the saturated monoglycerides is glyceryl monostearate. In some embodiments, the saturated glyceride is 2,3-dihydroxypropan-1-yl octadecanoate or 2,3-dihydroxypropan-1-yl palmitate.

In some embodiments, less than 10% (e.g., less than 5%, less than 2%, less than 1%) by weight of the composition is diglycerides. In some embodiments, less than 10% (e.g., less than 5%, less than 2%, less than 1%) by weight of the composition is triglycerides. In some embodiments, the composition does not comprise an acetylated monoglyceride (e.g., a monoglyceride wherein the hydroxyl groups of the glyceryl moiety are acetylated). In some embodiments, the composition comprises a range of about 50% to about 99% by weight of the one or more saturated glycerides. In some embodiments, the composition comprises a range of about 50% to about 99%, about 80% to about 99%, about 90% to about 99%, about 50% to about 80%, or about 50% to about 60% by weight of the one or more saturated glycerides. In some embodiments, the composition comprises a range of about 90% to about 95%%, about 93% to about 98%, or about 95% to about 99% by weight of the one or more saturated glycerides. In some embodiments, the composition comprises a range of about 50% to about 90% by weight of the one or more saturated glycerides. In some embodiments, the composition comprises about 63% by weight of the one or more saturated glycerides.

In some embodiments, the composition comprises a range of about 20 g/L to about 45 g/L of the one or more saturated glycerides. In some embodiments, the composition comprises a range of about 20 g/L to about 45 g/L, about 25 g/L to about 45 g/L, about 30 g/L to about 45 g/L, 35 g/L to about 45 g/L, about 40 g/L to about 45 g/L, 25 g/L to about 40 g/L, about 25 g/L to about 35 g/L, or about 25 g/L to about 30 g/L of the one or more saturated glycerides. In some embodiments, the composition comprises about 28.2 g/L by weight of the one or more saturated glycerides.

In some embodiments, the one or more surfactants are anionic, nonionic, or zwitterionic.

In some embodiments, the one or more surfactants are selected from fatty alcohol ethoxylates, amine oxides, sulfoxides, C10-C18 ethoxylated alcohols, C10-C18 ethoxylated propoxylated alcohols, C12-18 ether alcohols, alkyl(C12-C16) alcohol sulfate salt, C10-C18 alkyldimethylamine, benzene salts, monosulfobenzene derivatives, D-glucoside derivatives, C6-C16 alkyl-poly-D-glucosides, D-glucitol or derivatives thereof, C10-16-alkyl glycosides, ethanaminium esters with C16-18 and C18-unsaturated fatty acids, and combinations thereof.

In some embodiments, a surfactant is selected from sodium lauryl sulfate, sodium laureth sulfate, ammonium lauryl sulfate, ammonium laureth sulfate, sodium stearate, cocamide monoethanolamine (cocamide MEA), cocamide diethanolamine (cocamide

DEA), coco glucoside, decyl glucoside, lauryl glucoside, sodium lauryl glucose carboxylate, sodium cocoyl glutamate, disodium cocoyl glutamate, sodium lauroyl glutamate, sodium cocoyl hydrolyzed wheat protein, or sodium cocoyl hydrolyzed collagen. In some embodiments, a surfactant is an alkyl PEG sulfosuccinate such as disodium laureth sulfosuccinate or disodium deceth sulfosuccinate. In some embodiments, a surfactant is an alkyl sulfosuccinate such as disodium lauryl sulfosuccinate or disodium coco sulfosuccinate. In some embodiments, a surfactant is an amidopropyl betaine such as cocamidopropyl detaine (coco betaine, cocamido betaine). In some embodiments, a surfactant is an alkyl sulfoacetate such as sodium lauryl sulfoacetate. In some embodiments, a surfactant is an alkyl imidazoline such as sodium cocoamphoacetate, sodium cocoamphopropionate, disodium cocoamphodiacetate, or disodium cocoamphodipropionate. In some embodiments, a surfactant is an alkyl taurate such as sodium methyl cocoyl taurate or sodium methyl oleoyl taurate. In some embodiments, a surfactant is an acyl sarcosine such as sodium lauroyl sarcosinate, sodium cocoyl sarcosinate. In some embodiments, a surfactant is an acyl isethionate such as sodium cocoyl isethionate. In some embodiments, a surfactant is a sodium olivate, sodium cocoate, sodium canolate, potassium olivate, potassium canolate, potassium cocoate. In some embodiments, a surfactant is an alkyl ether sulfates such as sodium pareth sulfate or sodium cetareth sulfate.

In some embodiments, the one or more surfactants are anionic surfactants. In some embodiments, the one or more surfactants are carboxylic acids, sulfonic acids, alkylbenzene sulfonates, phosphoric acids, alcohol sulfates, or salts thereof. In some embodiments, the one or more surfactants are carboxylic acids or sulfonic acids. In some embodiments, the one or more surfactants are long chain water soluble sulfosuccinates.

In some embodiments, the surfactant is sodium decyl sulfate, sodium N-lauryl-N-methyltaurate, sodium tetradecyl sulfate, sodium dodecyl sulfate, sodium bis (2-ethylhexyl) sulfosuccinate, or a combination thereof.

In some embodiments, the one or more surfactants are lecithins, glycolipids, fatty alcohols, fatty acids, or fatty acid salts. In some embodiments, the one or more surfactants are fatty acids or fatty acid salts. In some embodiments, the fatty acids or fatty acid salts are monounsaturated fatty acids or salts thereof, polyunsaturated fatty acids or salts thereof, saturated fatty acids or salts thereof, or combinations thereof.

In some embodiments, the fatty acids or fatty acid salts are a C14 fatty acid or salt thereof, C16 fatty acid or salt thereof, a C18 fatty acid or salt thereof, or a combination thereof. In some embodiments, the fatty acids or fatty acid salts are a C16 fatty acid or salt thereof, and a C18 fatty acid or salt thereof.

In some embodiments the one or more fatty acids or salts thereof are lauric acid, myristic acid, palmitic acid, stearic acid, archidic acid, behenic acid, lignoceric acid, palmitoleic acid, oleic acid, linoleic acid, arachidonic acid, eicosapentaenoic acid, docosahexaenoic acid, or combinations thereof.

In some embodiments, the one or more surfactants are sodium stearate or sodium palmitate.

In some embodiments, the composition comprises about 70% 2,3-dihydroxypropan-1-yl octadecanoate and about 30% sodium stearate. In some embodiments, the composition comprises about 94% 2,3-dihydroxypropan-1-yl octadecanoate and about 6% sodium stearate. In some embodiments, the composition comprises 2,3-dihydroxypropan-1-yl octadecanoate and sodium stearate in a weight ratio of about 70:30 or about 94:6. In some embodiments, the composition further comprises citric acid, sodium bicarbonate, or both. In some embodiments, the composition comprises citric acid and sodium bicarbonate. In some embodiments, the molar ratio of the citric acid to sodium bicarbonate is in a range from about 1:5 to about 1:1, for example, about 1:3 to about 1:1, about 1:3 to about 1:2, about 1:3, about 1:2, or about 1:1. In some embodiments, the weight percentage of citric acid in the composition is in a range from about 0.2% to about 2%. In some embodiments, the weight percentage of sodium bicarbonate in the composition is in a range from about 0.2% to about 2%. In some embodiments, the collective weight percentage of citric acid and sodium bicarbonate in the composition is in a range from about 0.2% to about 2%.

In some embodiments, the composition comprises about 94% 2,3-dihydroxypropan-1-yl octadecanoate and about 6% sodium stearate and sodium palmitate in a 1:1 weight ratio. In some embodiments, the composition comprises 2,3-dihydroxypropan-1-yl octadecanoate, sodium stearate, and sodium palmitate in a weight ratio of about 70:15:15 or about 94:3:3. In some embodiments, the composition further comprises citric acid, sodium bicarbonate, or both. In some embodiments, the molar ratio of the citric acid to sodium bicarbonate is in a range from about 1:5 to about 1:1, for example, about 1:3 to about 1:1, about 1:3 to about 1:2, about 1:3, about 1:2, or about 1:1. In some embodiments, the weight percentage of citric acid in the composition is in a range from about 0.2% to about 2%. In some embodiments, the weight percentage of sodium bicarbonate in the composition is in a range from about 0.2% to about 2%. In some embodiments, the collective weight percentage of citric acid and sodium bicarbonate in the composition is in a range from about 0.2% to about 2%.

In some embodiments, the composition comprises about 70% 2,3-dihydroxypropan-1-yl octadecanoate and 2,3-dihydroxypropan-1-yl dodecanoate in a 1:1 weight ratio and about 30% of sodium stearate. In some embodiments, the composition comprises about 94% 2,3-dihydroxypropan-1-yl octadecanoate and 2,3-dihydroxypropan-1-yl dodecanoate in a 1:1 weight ratio and about 6% sodium stearate. In some embodiments, the composition comprises 2,3-dihydroxypropan-1-yl octadecanoate, 2,3-dihydroxypropan-1-yl dodecanoate, and sodium stearate in a weight ratio of about 35:35:30 or about 47:47:6. In some embodiments, the composition further comprises citric acid, sodium bicarbonate, or both. In some embodiments, the molar ratio of the citric acid to sodium bicarbonate is in a range from about 1:5 to about 1:1. In some embodiments, the weight percentage of citric acid in the composition is in a range from about 0.2% to about 2%. In some embodiments, the weight percentage of sodium bicarbonate in the composition is in a range from about 0.2% to about 2%. In some embodiments, the collective weight percentage of citric acid and sodium bicarbonate in the composition is in a range from about 0.2% to about 2%.

In some embodiments, the composition comprises about 70% 2,3-dihydroxypropan-1-yl octadecanoate and 2,3-dihydroxypropan-1-yl palmitate in an about 1:1 weight ratio and about 30% of sodium stearate and sodium palmitate in an about 1:1 weight ratio. In some embodiments, the composition comprises about 94% 2,3-dihydroxypropan-1-yl octadecanoate and 2,3-dihydroxypropan-1-yl palmitate in an about 1:1 weight ratio and about 6% of sodium stearate and sodium palmitate in an about 1:1 weight ratio. In some embodiments, the composition comprises 2,3-dihydroxypropan-1-yl octadecanoate, 2,3-dihydroxypropan-1-yl palmitate, sodium stearate, and sodium palmitate in a weight ratio of about 35:35:15:15 or about 47:47:3:3. In some embodiments, the composition further comprises citric acid, sodium bicarbonate, or both. In some embodiments, the molar ratio of the citric acid to sodium bicarbonate is in a range from about 1:5 to about 1:1, for example, about 1:3 to about 1:1, about 1:3 to about 1:2, about 1:3, about 1:2, or about 1:1. In some embodiments, the weight percentage of citric acid in the composition is in a range from about 0.2% to about 2%. In some embodiments, the weight percentage of sodium bicarbonate in the composition is in a range from about 0.2% to about 2%. In some embodiments, the collective weight percentage of citric acid and sodium bicarbonate in the composition is in a range from about 0.2% to about 2%.

In some embodiments, the one or more surfactants have a pKa that is lower than the pKa of the food-safe antimicrobial. For example, the one or more anionic surfactants can have a pKa that is lower than the pKa of the food-safe antimicrobial.

In some embodiments, the composition comprises about 1% to about 10%, about 5% to about 10%, about 1% to about 5% by weight of the one or more surfactants. In some embodiments, the composition comprises about 2% to about 6%, about 3% to about 6%, about 2% to about 4%, or about 2% to about 3% by weight of the one or more surfactants. In some embodiments, the composition comprises about 4% by weight of the one or more surfactants.

In some embodiments, the composition comprises about 0.5 g/L to about 4.5 g/L, about 0.5 g/L to about 2.5 g/L, about 1.6 g/L to about 2.6 g/L, about 1.3 g/L to about 2.3 g/L. In some embodiments, the composition comprises about 1.8 g/L of the one or more surfactants.

In some embodiments, the one or more food-safe antimicrobials are an organic acid antimicrobial.

In some embodiments, at least one of the one or more food-safe antimicrobials is a compound of Formula (I)

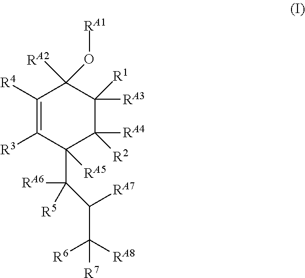

wherein:

one of the following applies:

R^{A1} and R^{A2} join to form a double bond;

R^{A3} and R^{A4} join to form a double bond;

R^{A5} and R^{A6} join to form a double bond;

and R^{A7} and R^{A8} join to form a double bond; or

(ii) R^{A1} is selected from H, C₁-C₆ alkyl, and C₁-C₆ haloalkyl;

R^{A2} and R^{A3} join to form a double bond;

R^{A4} and R^{A5} join to form a double bond;

R^{A6}, R^{A7}, and R^{A8} are independently selected from H, C₁-C₆ alkyl, and halo; or any two adjacent R^{A6}, R^{A7}, or R^{A8} join to form a double bond;

R¹, R², R³, and R⁴ are independently selected from H, C₁-C₆ alkyl, hydroxyl, halo, cyano, nitro, C₁-C₆ alkoxy, —NR′R″, —C(O)NR′R″, —C(O)C₁-C₆ alkyl, —C(O)OC₁-C₆ alkyl, C₁-C₆ haloalkoxy, and C₁-C₆ haloalkyl;

R⁵, R⁶, and R⁷ are independently selected from H, C₁-C₆ alkyl, C2-6 alkenyl, hydroxyl, halo, C₁-C₆ alkoxy, C₁-C₆ haloalkyl, 5-10 membered heteroaryl, C₆-C₁₀ aryl, C₃-C₈ cycloalkyl, 3-10 membered heterocycloalkyl, wherein the 5-10 membered heteroaryl, C₆-C₁₀ aryl, C₃-C₈ cycloalkyl, 3-10 membered heterocyclyl are optionally substituted with one or more independently selected R^{B};

or, when (i) applies, R² and R⁶ are taken together with the atoms to which they are attached to form

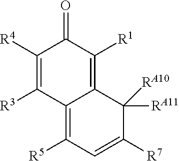

or, when (ii) applies, R^{A1} and R¹ are taken together with the atoms to which they are attached to form a 5-6 membered heterocyclyl optionally substituted with one or more independently selected R″′;

or, when (ii) applies, R⁷ and R^{A8} are taken together with the atom to which they are attached to form

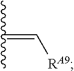

R^{A9} is selected from H or —C(O)NR′R″;

R^{A10} and R^{A11} are selected from H and C₁-C₆ alkyl,

or R^{A10} and R⁷, together with the atoms to which they are connected, join to form a C₁₄ cycloalkyl optionally substituted with one or more independently selected C₁-C₆ alkyl or C(O)OH;

each occurrence of R^{B} is independently selected from C₁-C₆ alkyl, hydroxyl, halo, cyano, nitro, C₁-C₆ alkoxy, —NR′R″, —C(O)NR′R″, —C(O)C₁-C₆ alkyl, —C(O)OC₁-C₆ alkyl, C₁-C₆ haloalkoxy, and C₁-C₆ haloalkyl;

each occurrence of R′ and R″ is independently selected from H and C₁-C₆ alkyl, or R′ and R″, together with the atom to which they are attached, join to form a 3-6 membered heterocyclyl; and

each occurrence of R″′ is independently selected from H, C1-C6 alkyl, C₁-C₆ haloalkyl, and halo.

In some embodiments, (i) applies.

In some embodiments, R² and R⁶ are taken together with the atoms to which they are attached to form

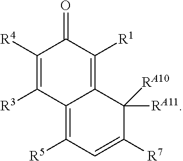

In some embodiments, R^{A10} and R⁷, together with the atoms to which they are connected, join to form a C₁₄ cycloalkyl optionally substituted with one or more independently selected C₁-C₆ alkyl or C(O)OH.

In some embodiments, (ii) applies.

In some embodiments, R^{A1} and R¹ are taken together with the atoms to which they are attached to form a 5-6 membered heterocyclyl optionally substituted with one or more independently selected R″′.

In some embodiments, R⁷ and R^{A8} are taken together with the atom to which they are attached to form

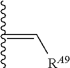

### and R^{A9} is H.

In some embodiments, R^{A6} and R^{A7} join to form a double bond. In some embodiments, R^{A7} and R^{A8} join to form a double bond.

In some embodiments, R², R³, and R⁴ are independently selected from H, C₁-C₆ alkyl, hydroxyl, and C₁-C₆ alkoxy. In some embodiments, R⁵, R⁶, and R⁷ are independently selected from H and C₆-C₁₀ aryl.

In some embodiments, at least one of the one or more food-safe antimicrobials is a compound of Formula (II)

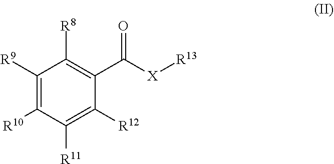

wherein:

X is selected from O and NH;

R⁸, R⁹, R¹⁰, R¹¹, and R¹² are independently selected from H, C₁-C₆ alkyl, C₂-C₆ alkenyl, C₁-C₆ alkoxy, hydroxyl, halo, -(C₁-C₆ alkyl)ₘC(O)C₁-C₆ alkyl, —NHC(O)H, —OC(O)C₆-C₁₀ aryl, wherein the C₂-C₆ alkenyl and —OC(O)C₆-C₁₀ aryl are optionally substituted with one or more independently selected R^{C};

or any two adjacent R⁸, R⁹, R¹⁰, R¹¹, and R¹² are taken together with the atoms to which they are attached to form a 5-7 membered heterocyclyl optionally fused to a C₆-C₁₀ aryl optionally substituted with one or more independently selected C₁-C₆ alkyl, halo, hydroxyl, or —C(O)OC₁-C₆ alkyl;

or R¹² and R¹³ are taken together with the atoms to which they are attached to form a 5-6 membered heterocyclyl;

R¹³ is selected from C₁-C₆ alkyl, C₆-C₁₀ aryl, 5-9 membered heterocyclyl, wherein the C₆-C₁₀ aryl and 5-9 membered heterocyclyl are optionally substituted with one or more independently selected R^{D};

each occurrence of R^{C} is independently selected from C₁-C₆ alkyl, C₁-C₆ alkoxy, and —C(O)OH;

each occurrence of R^{D} is independently selected from C₁-C₆ alkyl, C₁-C₆ alkoxy, oxo, —C(O)OH, -(C₁-C₆ alkyl)ₘC(O)C₁-C₆ alkyl, and —OC(O)C₁-C₆ alkyl; and

m is 0 or 1.

In some embodiments, R⁸, R⁹, R¹⁰, R¹¹, and R¹² are independently selected from H, C₁-C₆ alkyl, C₂-C₆ alkenyl, C₁-C₆ alkoxy, hydroxyl, and halo. In some embodiments, any two adjacent R⁸, R⁹, R¹⁰, R¹¹, and R¹² are taken together with the atoms to which they are attached to form a 5-7 membered heterocyclyl optionally fused to a C₆-C₁₀ aryl optionally substituted with one or more independently selected C₁-C₆ alkyl, halo, hydroxyl, or —C(O)OC₁-C₆ alkyl

In some embodiments, R¹² and R¹³ are taken together with the atoms to which they are attached to form a 5-6 membered heterocyclyl. In some embodiments, R¹³ is C₁-C₆ alkyl.

In some embodiments, at least one of the one or more food-safe antimicrobials is a compound of Formula (III)

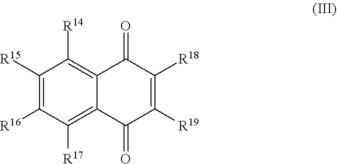

wherein:

R¹⁴, R¹⁵, R¹⁶, R¹⁷, R¹⁸, and R¹⁹ are independently selected from H, C₁-C₆ alkyl, C₁-C₆ alkoxy, hydroxyl, and halo;

or R¹⁸ and R¹⁹ are taken together with the atoms to which they are attached to form

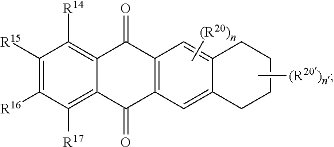

R²⁰ and R^{20′} are independently selected from hydroxyl, C₁-C₆ alkyl, halo, —C(O)C₁-C₆ alkyl, and —O—(3-8 membered heterocyclyl) optionally substituted with one or more independently selected hydroxyl, C₁-C₆ alkyl, or amino;

n is 0, 1, or 2; and

n′ is 0, 1, 2, or 3.

In some embodiments, R¹⁴, R¹⁵, R¹⁶, R¹⁷, R¹⁸ and R¹⁹ are independently selected from H, C₁-C₆ alkyl, and hydroxyl.

In some embodiments, R¹⁸ and R¹⁹ are taken together with the atoms to which they are attached to form

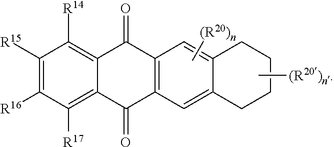

In some embodiments, n is 2 and each R²° is hydroxyl. In some embodiments, n is 3 and each R^{20′} is independently selected from hydroxyl, —C(O)C₁-C₆ alkyl, and —O—(3-8 membered heterocyclyl) optionally substituted with one or more independently selected hydroxyl, C₁-C₆ alkyl, or amino.

In some embodiments, at least one of the one or more food-safe antimicrobials is a compound of Formula (IV)

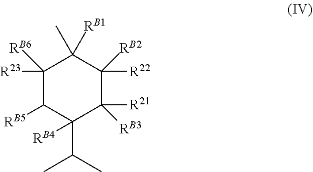

wherein:

one of the following applies:

three adjacent pairs of R^{B1}, R^{B2}, R^{B3}, R^{B4}, R^{B5}, and R^{B6} join together to form double bonds;

(ii) R^{B1} and R^{B2} join to form a double bond;

R^{B4} and R^{B5} join to form a double bond;

R²¹ and R^{B3} join to form an oxo; and

R²³ and R^{B6} join to form an oxo; or

(iii) R^{B1}, R^{B2}, R^{B3}, R^{B4}, R^{B5}, and R^{B6} are each H;

when (i) or (iii) applies, R²¹, R²², and R²³ are independently selected from H, C₁-C₆ alkyl, C₁-C₆ alkoxy, and hydroxyl; and

when (ii) applies, R²² is selected from H, C₁-C₆ alkyl, C₁-C₆ alkoxy, and hydroxyl.

In some embodiments, (i) applies. In some embodiments, (ii) applies. In some embodiments, (iii) applies.

In some embodiments, at least one of the one or more food-safe antimicrobials is a compound of Formula (V)

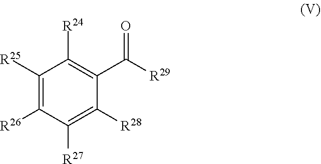

wherein:

R²⁴, R²⁵, R²⁶, R²⁷, and R²⁸ are independently selected from H, C₁-C₆ alkyl, C₁-C₆ alkoxy, and hydroxyl;

or any two adjacent R²⁴, R²⁵, R²⁶, R²⁷, and R²⁸ taken together with the atoms to which they are attached form a 5-9 membered heterocycloalkenyl optionally substituted with one or more independently selected C₁-C₆ alkyl, oxo, and —C(O)C₁-C₆ alkyl;

R²⁹ is selected from C₁-C₆ alkyl and -(C₁-C₆ alkyl)ₚC₆-C₁₀ aryl, wherein the -(C₁-C₆ alkyl)ₚC₆-C₁₀ aryl is optionally substituted with C₁-C₆ alkoxy;

or R²⁸ and R²⁹ taken together with the atoms to which they are attached form

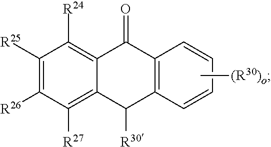

each occurrence of R³⁰ and R^{30′} is independently selected from H, C₁-C₆ alkyl optionally substituted with hydroxyl, hydroxyl, and 5-6 membered heterocyclyl optionally substituted with one or more independently selected hydroxyl or hydroxymethyl;

o is 0, 1, or 2; and

p is 0 or 1.

In some embodiments, R²⁴ and R²⁵ taken together with the atoms to which they are attached form a 5-9 membered heterocycloalkenyl optionally substituted with one or more independently selected C₁-C₆ alkyl, oxo, and —C(O)C₁-C₆ alkyl.

In some embodiments, R²⁹ is C₁-C₆ alkyl. In some embodiments, R²⁹ is -(C₁-C₆ alkyl)ₚC₆-C₁₀ aryl, wherein the —(C₁-C₆ alkyl)ₚC₆-C₁₀ aryl is optionally substituted with C₁-C₆ alkoxy. In some embodiments, p is 0. In some embodiments, p is 1.

In some embodiments, R²⁸ and R²⁹ taken together with the atoms to which they are attached form

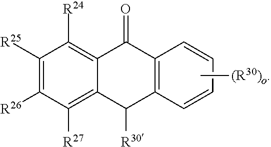

In some embodiments, R³⁰is 5-6 membered heterocyclyl optionally substituted with one or more independently selected hydroxyl or hydroxymethyl. In some embodiments, o is 2 and each R^{30′} is independently selected from C₁-C₆ alkyl optionally substituted with hydroxyl and hydroxyl.

In some embodiments, at least one of the one or more food-safe antimicrobials is a compound of Formula (VI)

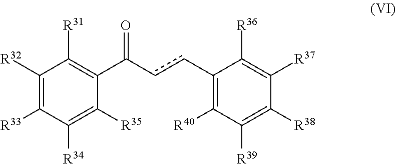

wherein:

[symbol] is a single or double bond;

R³¹, R³², R³³, R³⁴, R³⁵, R³⁶, R³⁷, R³⁸, R³⁹, and R⁴⁰ are independently selected from H, C₁-C₆ alkyl, C₁-C₆ alkoxy, halo, and hydroxyl.

In some embodiments, [symbol] is a single bond. In some embodiments, [symbol] is a double bond.

In some embodiments, R³¹, R³², R³³, R³⁴, R³⁵, R³⁶, R³⁷, R³⁸, R³⁹, and R⁴⁰ are independently selected from H, C₁-C₆ alkyl, C₁-C₆ alkoxy, halo, and hydroxyl.

In some embodiments, at least one of the one or more food-safe antimicrobials is a compound of Formula (VII)

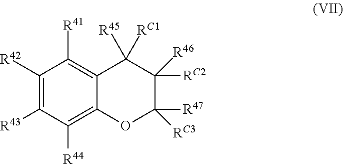

wherein:

one of the following applies:

R^{C1} and R⁴⁵ join to form an oxo; and

R^{C2} and R^{C3} are each H, or R^{C2} and R^{C3} join to form a double bond; or

(ii) R^{C3} and R⁴⁷ join to form an oxo; and

R^{C1} and R^{C2} are each H, or R^{C2} and R^{C3} join to form a double bond;

R⁴¹, R⁴², R⁴³, R⁴⁴, R⁴⁵, R⁴⁶, and R⁴⁷ are independently selected from H, C₁-C₆ alkyl, C₂-C₆ alkenyl, C₁-C₆ alkoxy, hydroxyl, —OC(O)C₁-C₆ alkyl, and -(C₁-C₆ alkyl)_{q}C₆-C₁₀ aryl optionally substituted with one or more independently selected C₁-C₆ alkyl, C₁-C₆ alkoxy, or hydroxyl;

or one or more pairs of adjacent R⁴¹, R⁴², R⁴³, R⁴⁴, R⁴⁵, R⁴⁶, and R⁴⁷ taken together with the atoms they are attached to form one or more independently selected 5-6 membered heterocyclyl, 5-6 membered heterocycloalkenyl, C₆-C₁₀ aryl, or 5-10 membered heteroaryl, wherein the 5-6 membered heterocyclyl, 5-6 membered heterocycloalkenyl, C₆-C₁₀ aryl, and 5-10 membered heteroaryl are optionally substituted with one or more independently selected C₁-C₆ alkyl, C₁-C₆ alkoxy, or hydroxyl;

or, when (i) applies, R^{C2}, R^{C3}, R⁴⁶, and R⁴⁷ taken together with the atoms they are attached to form

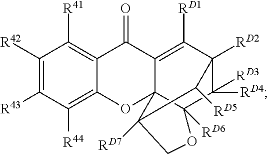

R^{D1}, R^{D2}, R^{D3}, R^{D4}, R^{D5}, R^{D6}, and R^{D7} are independently selected from H, C₁-C₆ alkyl, C₂-C₆ alkenyl optionally substituted with —C(O)OH, C₁-C₆ alkoxy, and hydroxyl, or R^{D3} and R^{D4} join to form an oxo; and

q is 0 or 1.

In some embodiments, (i) applies. In some embodiments, R^{C2} and R^{C3} are each H. In some embodiments, R^{C2} and R^{C3} join to form a double bond.

In some embodiments, R^{C2}, R^{C3}, R⁴⁶, and R⁴⁷ taken together with the atoms they are attached to form

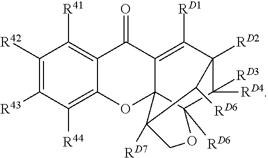

In some embodiments, (ii) applies. In some embodiments, R^{C1} and R^{C2} are each H. In some embodiments, R^{C2} and R^{C3} join to form a double bond.

In some embodiments, R⁴¹ and R⁴² taken together with the atoms they are attached to form one or more independently selected 5-6 membered heterocyclyl, 5-6 membered heterocycloalkenyl, C₆-C₁₀ aryl, or 5-10 membered heteroaryl, wherein the 5-6 membered heterocyclyl, 5-6 membered heterocycloalkenyl, C₆-C₁₀ aryl, and 5-10 membered heteroaryl are optionally substituted with one or more independently selected C₁-C₆ alkyl, C₁-C₆ alkoxy, or hydroxyl. In some embodiments, R⁴³ and R⁴⁴ taken together with the atoms they are attached to form one or more independently selected 5-6 membered heterocyclyl, 5-6 membered heterocycloalkenyl, C₆-C₁₀ aryl, or 5-10 membered heteroaryl, wherein the 5-6 membered heterocyclyl, 5-6 membered heterocycloalkenyl, C₆-C₁₀ aryl, and 5-10 membered heteroaryl are optionally substituted with one or more independently selected C₁-C₆ alkyl, C₁-C₆ alkoxy, or hydroxyl.

In some embodiments, at least one of the one or more food-safe antimicrobials is a compound of Formula (VIII)

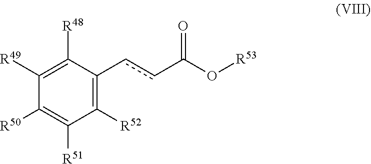

wherein:

[symbol] is a single or double bond;

R⁴⁸, R⁴⁹, R⁵⁰, R⁵¹, and R⁵² are independently selected from H, C₁-C₆ alkyl, C₁-C₆ alkoxy, halo, and hydroxyl; and

R⁵³ is selected from H, C₁-C₆ alkyl, and C₁-C₆ haloalkyl.

In some embodiments, [symbol] is a single bond. In some embodiments, [symbol] is a double bond.

In some embodiments, R⁴⁸, R⁴⁹, R⁵⁰, R⁵¹, and R⁵² are independently selected from H and C₁-C₆ alkoxy.

In some embodiments, R⁵³ is C₁-C₆ alkyl.

In some embodiments, the one or more food-safe antimicrobials is sodium benzoate, potassium sorbate, carvacrol, chalcone, fludioxonil, 2-hydroxychalcone, 4-hydroxychalcone, 4′-hydroxychalcone, 2,2′-dihydroxychalcone, 2,4′-dihydroxychalcone, 2′,4-dihydroxychalcone, 2′,4′-dihydroxychalcone, 2′,4,4′-trihydroxychalcone, 2′,4,4′-trihydroxychalcone Intermediate, violastyrene, obtusaquinone, apiole, piperine, celastrol, eugenol, arthonoic acid, leoidin, antimycin A, antimycin Al, diffractaic acid, ethyl orsellinate, methyl orsellinate, mycophenolic acid, ethyl dichloroorsellinate, angolensin, isocotoin, eupatoriochromene, xanthoxylin, usnic acid, aloin, ononetin, apocynin, isopomiferin, deoxysappanone B7,4′-dimethyl ether, chrysin dimethyl ether, bergapten, gambogic acid, 2-hydroxyxanthone, isopimpinellin, xanthyletin, acetyl hymetochrome, nobiletin, hymechrome, methoxsalen, 4-methylesculetin, tangeritin, khellin, flavone, 3,4′,5,6,7-pentamethoxyflavone, deguelin(-), citropten, deoxysappanone B trimethyl ether, deoxysappanone B 7,3′dimethyl ether, 2′,4′-dihydroxy-4-methoxychalcone, daunorubicin hydrochloride, plumbagin, menadione, thymoquinone, levomenthol, thymol, methyl trimethoxycinnamate, chavicol, cinnamylphenol, benzoate, napthoquinone, phenone, acetophenone, benzophenone, phenylacetophenone, salicylic acid, sodium salicylate, methyl salicylate, or chitosan. In some embodiments, the one or more food-safe antimicrobials is a benzoate salt. In some embodiments, the one or more food-safe antimicrobials is sodium benzoate, potassium benzoate, potassium sorbate, or a combination thereof. In some embodiments, the one or more food-safe antimicrobials is sodium benzoate. In some embodiments, the one or more food-safe antimicrobials is chalcone. In some embodiments, the one or more food-safe antimicrobials is chitosan. In some embodiments, the one or more food-safe antimicrobials is salicylic acid. In some embodiments, the one or more food-safe antimicrobials is sodium salicylate. In some embodiments, the one or more food-safe antimicrobials is methyl salicylate.

In some embodiments, the composition comprises about 0.1% to about 40%, about 1% to about 40%, about 10% to about 40%, about 20% to about 40%, about 30% to about 40%, about 1% to about 30%, about 0.1% to about 20%, about 0.1% to about 10%, or about 0.1% to about 1% by weight of the one or more food-safe antimicrobials. In some embodiments, the composition comprises about 4% to about 16% by weight of the one or more food-safe antimicrobials. In some embodiments, the composition comprises about 0.1 g/L to about 10 g/L, 5 g/L to about 10 g/L, 0.1 g/L to about 6 g/L, 0.1 g/L to about 4 g/L, or 0.1 g/L to about 2 g/L of the one or more food-safe antimicrobials. In some embodiments, the composition comprises about 1.5 g/L to about 7.5 g/L of the one or more food-safe antimicrobials.

In some embodiments, the composition further comprises one or more additives. For example, the additives can include water, a stabilizer, a buffer, an essential oil, a preservative, a vitamin, a mineral, a pigment, an aroma, an enzyme, a catalyst, an anti-oxidant, or a combination thereof. In some embodiments, the one or more additives alter the taste, look, texture, smell, or durability of the composition.

In some embodiments, the stabilizer is alginic acid, agar, carrageenan, gelatin, pectin, or combinations thereof.

In some embodiments, the buffer is a citrate salt, a phosphate salt, a tartrate salt, or combinations thereof.

In some embodiments, the essential oil is African basil, bishop's weed, cinnamon, clove, coriander, cumin, garlic, kaffir lime, lime, lemongrass, mustard oil, menthol, oregano, rosemary, savory, Spanish oregano, thyme, anise, ginger, bay leaf, sage, bergamot, eucalyptus, melaleuca, peppermint, spearmint, wintergreen, cannibis, marjoram, orange, rose, other plant-derived oils, or combinations thereof

In some embodiments, the preservative is a nitrite derivative or salt thereof, a sulfite derivative or salt thereof, a benzoate derivative or salt thereof, or combinations thereof. In some embodiments, the preservative is butylated hydroxyanisole, butylated hydroxytoluene, or combinations thereof. In some embodiments, the mixture or composition (e.g., coating or coating agent) comprises one or more (e.g., 1, 2, or 3) preservatives. In some embodiments, the one or more preservatives comprise one or more antioxidants, one or more antimicrobial agents, one or more chelating agents, or any combination thereof. Exemplary preservatives include, but are not limited to, vitamin E, vitamin C, butylatedhydroxyanisole (BHA), butylatedhydroxytoluene (BHT), sodium benzoate, disodium ethylenediaminetetraacetic acid (EDTA), citric acid, benzyl alcohol, benzalkonium chloride, butyl paraben, chlorobutanol, meta cresol, chlorocresol, methyl paraben, phenyl ethyl alcohol, propyl paraben, phenol, benzoic acid, sorbic acid, methyl paraben, propyl paraben, bronidol, and propylene glycol.

In some embodiments, the mixture or composition (e.g., coating or coating agent) comprises from about 0.1% to about 40% by weight of the one or more preservatives. For example, the mixture or composition (e.g., coating or coating agent) comprises from about 0.1% to about 20%, from about 0.1% to about 5%, from about 1% to about 10%, from about 5% to about 10%, from about 10% to about 20%, from about 20% to about 30%, from about 30% to about 40%.

In some embodiments, the vitamin is vitamin A or derivatives thereof, vitamin B or derivatives thereof, vitamin C or derivatives thereof, vitamin D or derivatives thereof, vitamin E or derivatives thereof, or combinations thereof.

In some embodiments, the mineral is a macromineral, a trace mineral, or combinations thereof. In some embodiments the mineral is iron, manganese, copper, iodine, zinc, cobalt, fluoride, selenium, or combinations thereof.

In some embodiments, the pigment is blue #1, blue #2, green #3, red #3, red #40, yellow #5, yellow #6, citrus red #2, corresponding aluminum lakes thereof, or combinations thereof.

In some embodiments, the enzyme is an enzyme preparation such as a decarboxylase, an aminopeptidase, an amylase, an asparaginase, a carboxypeptidase, a catalase, a cellulase, a chymosin, a cyprosin, a ficin, a glucanase, an isomerase, a glutaminase, an invertase, a lactase, a lipase, a lyase, a lysozyme, a mannase, an oxidase, a pectinase, a peptidase, a peroxidase, a phospholipase, a protease, a trypsin, a urease, or combinations thereof.

In some embodiments, the anti-oxidant is an anti-oxidant vitamin, a tocopherol, a gallate or derivative thereof, or combinations thereof. In some embodiments, the anti-oxidant is 4-hexylresorcinol ascorbic acid or a fatty acid esters thereof, sodium ascorbate, calcium ascorbate, citric acid, erythorbic acid, sodium erythorbate, tertiary-butyl hydroquinone, butylated hydroxyanisole, butylated hydroxytoluene, or combinations thereof.

In some embodiments, the composition (e.g., coating agent) can be dissolved, mixed, dispersed, or suspended in a solvent to form a mixture (e.g., solution, suspension, or colloid). Examples of solvents that can be used include water, methanol, ethanol, isopropanol, butanol, acetone, ethyl acetate, chloroform, acetonitrile, tetrahydrofuran, diethyl ether, methyl tert-butyl ether, or combinations thereof. For example, the solvent is water. For example, the solvent is ethanol.

The concentration of the composition (e.g., coating agent) in the solution or mixture (e.g., solution, suspension, or colloid) is in a range from about 1 mg/mL to about 200 mg/mL. For example, from about 1 to about 100 mg/mL, from about 1 to about 75 mg/mL, from about 1 to about 50 mg/mL, from about 10 to about 50 mg/mL, from about 20 to about 40 mg/mL, or from about 35 to about 45 mg/mL. For example, the concentration of the composition (e.g., coating agent) in the mixture (e.g., solution, suspension, or colloid) is in a range of about 30 mg/mL or about 40 mg/mL.

To improve the solubility of the coating agent in the solvent, or to allow the coating agent to be suspended or dispersed in the solvent, the coating agent can further include an emulsifier, as described below. When the coatings are to be formed over plants or other edible products, it may be preferable that the emulsifier be safe for consumption. Furthermore, it is also preferable that the emulsifier either not be incorporated into the coating or, if the emulsifier is incorporated into the coating, that it does not degrade the performance of the coating.

Further, organic salts, such as the fatty acid salts as described herein, can increase the solubility of the coating agent or allow the coating agent to be suspended or dispersed in solvents having a substantial water content (e.g., solvents that are at least 50% water by volume), provided that the concentration of the salts is not too low relative to the fatty acids and/or esters thereof.

The coating solutions/suspensions/colloids can further include a wetting agent that serves to reduce the contact angle (i.e., an angle of the outer surface of a droplet of the liquid measured where the liquid-vapor interface meets the liquid-solid interface) between the solution/suspension/colloid and the surface of the substrate being coated. The wetting agent can be included as a component of the coating agent and therefore added to the solvent at the same time as other components of the coating agent. Alternatively, the wetting agent can be separate from the coating agent and can be added to the solvent either before, after, or at the same time as the coating agent. Alternatively, the wetting agent can be separate from the coating agent, and can be applied to a surface before the coating agent in order to prime the surface.

The wetting agent can be a fatty acid or salt or ester thereof, e.g., a compound of Formula I, Formula II, and all subformulas described herein. In particular, the wetting agent compounds can each have a carbon chain length of 13 or less. For example, the carbon chain length in a range of 7 to 13, or in a range of 8 to 12. The wetting agent can also or alternatively be one or more of a phospholipid, a lysophospholipid, a glycoglycerolipid, a glycolipid, an ascorbyl ester of a fatty acid, an ester of lactic acid, an ester of tartaric acid, an ester of malic acid, an ester of fumaric acid, an ester of succinic acid, an ester of citric acid, an ester of pantothenic acid, or a fatty alcohol derivative (e.g., an alkyl sulfate). In some embodiments, the wetting agents included in the mixtures herein are edible and/or safe for consumption. Further examples of wetting agents are described below.

In some embodiments, compounds used as wetting agents can also (or alternatively) be used as emulsifiers. For example, in some embodiments, a medium chain fatty acid (e.g., having a carbon chain length of 7, 8, 9, 10, 11, 12, or 13) or salt or ester thereof is used as an emulsifier (and optionally also functions as a wetting agent) in the composition, thereby enabling the composition to be dissolved or suspended in the solvent. In some embodiments, the emulsifier is cationic. In some embodiments, the emulsifier is anionic. In some embodiments, the emulsifier is zwitterionic. In some embodiments, the emulsifier is uncharged.

In some embodiments, the composition (e.g., coating or coating agent) comprises one or more (e.g., 1, 2, or 3) wetting agents, surfactants, and/or emulsifiers. In some embodiments, the one or more wetting agents, surfactants, and/or emulsifiers comprise sodium bicarbonate, citric acid, cetyl trimethylammonium bromide, sodium lauryl sulfate, ammonium lauryl sulfate, sodium laureth sulfate, sodium myreth sulfate, docusate, sodium dodecyl sulfate, sodium stearate, sodium lauroyl sarcosinate, perfluorononanoate, perfluorooctanoate, perfluorooctanesulfonate (PFOS), perfluorobutanesulfonate, alkyl-aryl ether phosphates, alkyl ether phosphates, 2-[4-(2,4,4-trimethylpentan-2-yl)phenoxy] ethanol (Triton X-100), 3-[(3 -Cholamidopropyl)dimethylammonio]-1-propanesulfonate (CHAPS), cholic acid, nonyl phenoxypolyethoxylethanol (NP-40), octyl thioglucoside, octyl glucoside, dodecyl maltoside, octenidine dihydrochloride, cetrimonium bromide (CTAB), cetylpyridinium chloride (CPC), benzalkonium chloride (BAC), benzethonium chloride (BZT), dim ethyldioctadecylammonium chloride, and dioctadecyldimethylammonium bromide (DODAB), cocamidopropyl hydroxysultaine, cocamidopropyl betaine, phosphatidylserine, phosphatidylethanolamine, phosphatidylcholine, phosphatidylinositol, phosphatidic acid, lysophosphatidylserine, lysophosphatidylethanolamine, lysophosphatidylcholine, lysophosphatidylinositol, lysophosphatidic acid, sphingomyelins, lauryldimethylamine oxide, myristamine oxide, octaethylene glycol monododecyl ether, pentaethylene glycol monododecyl ether, polyethoxylated tallow amine, cocamide monoethanolamine, cocamide diethanolamine, poloxamers, fatty acid esters of polyhydroxy compounds, fatty acid esters of glycerol, glycerol monostearate, glycerol monolaurate, fatty acid esters of sorbitol, sorbitan monolaurate, sorbitan monostearate, sorbitan tristearate, Tween 20, Tween 40, Tween 60, Tween 80, fatty acid esters of sucrose, alkyl polyglucosides, alkyl polyglycoside, decyl glucoside, lauryl glucoside, octyl glucoside, fatty acid esters of sucrose, sucrose monostearate, sucrose distearate, sucrose tristearate, sucrose polystearate, sucrose monopalmitate, sucrose dipalmitate, sucrose tripalmitate, sucrose polypalmitate, sucrose monomyristate, sucrose dimyristate, sucrose trimyristate, sucrose polymyristate, sucrose monolaurate, sucrose dilaurate, sucrose trilaurate, or sucrose polylaurate. For example, the one or more wetting agents, surfactants, and/or emulsifiers comprises sodium lauryl sulfate. For example, the one or more wetting agents, surfactants, and/or emulsifiers comprises sodium bicarbonate. For example, the one or more wetting agents, surfactants, and/or emulsifiers comprises citric acid.

In some embodiments, the mixture or composition (e.g., coating or coating agent) comprises from about 0.1% to about 40% by weight of the one or more wetting agents, surfactants, and/or emulsifiers. For example, the mixture or composition (e.g., coating or coating agent) comprises from about 0.1% to about 30%, from about 0.1% to about 20%, from about 0.1% to about 10%, from about 0.1% to about 5%, from about 0.1% to about 2%, from about 0.1% to about 1%, from about 0.1% to about 0.5%.

Any of the coating agents or coatings formed thereof that are described herein can be flavorless or have high flavor thresholds, e.g. above 500 ppm, and can be odorless or have a high odor threshold. In some embodiments, the materials included in any of the coatings described herein can be substantially transparent. For example, the coating agent, the solvent, and/or any other additives included in the coating can be selected so that they have substantially the same or similar indices of refraction. By matching their indices of refraction, they may be optically matched to reduce light scattering and improve light transmission. For example, by utilizing materials that have similar indices of refraction and have a clear, transparent property, a coating having substantially transparent characteristics can be formed.

In some embodiments, the composition comprises about 50% to about 99% by weight of the one or more saturated glycerides, about 1% to about 10% by weight of the one or more surfactants, and about 1% to about 50% by weight of the one or more food-safe antimicrobials. In some embodiments, the composition comprises about 55% to about 75% by weight of the one or more saturated glycerides, about 2% to about 8% by weight of the one or more surfactants, and about 3% to about 35% by weight of the one or more food-safe antimicrobials. In some embodiments, the composition comprises about 93% to about 97% by weight of the one or more saturated glycerides, about 1% to about 6% by weight of the one or more surfactants, and about 1% to about 16% by weight of the one or more food safe antimicrobials.

In some embodiments, the composition comprises about 20 g/L to about 45 g/L of the one or more saturated glycerides, about 0.5 g/L to about 4.5 g/L of the one or more surfactants, and about 0.1 g/L to about 10 g/L of the one or more food-safe antimicrobials. In some embodiments, the composition comprises about 27.5 g/L to about 28.5 g/L of the one or more saturated glycerides, about 1.5 g/L to about 2.1 g/L of the one or more surfactants, and about 1.5 g/L to about 7.5 g/L of the one or more food-safe antimicrobials.

In some embodiments, the composition comprises about 50% to about 99% by weight of the one or more C14-C18 monoglycerides, about 1% to about 10% by weight of the one or more fatty acids or salts thereof, and about 1% to about 50% by weight of the one or more organic acids. In some embodiments, the composition comprises about 93% to about 97% by weight of the one or more C14-C18 monoglycerides, about 1% to about 6% by weight of the one or more fatty acids or salts thereof, and about 1% to about 16% by weight of the one or more organic acids.

In some embodiments, the composition comprises about 20 g/L to about 45 g/L of the one or more C14-C18 monoglycerides, about 0.5 g/L to about 4.5 g/L of the one or more fatty acids or salts thereof, and about 0.1 g/L to about 10 g/L of the one or more organic acids. In some embodiments, the composition comprises about 27.5 g/L to about 28.5 g/L of the one or more C14-C18 monoglycerides, about 1.5 g/L to about 2.1 g/L of the one or more fatty acids or salts thereof, and about 1.5 g/L to about 7.5 g/L of the one or more organic acids.

In some embodiments, the composition comprises about 50% to about 99% by weight of glycerol monostearate, about 1% to about 10% by weight of sodium lauryl sulfate, sodium tetradecyl sulfate, or sodium bis (2-ethyhexyl) sulfosuccinate, and about 1% to about 50% by weight of benzoate, chalcone, chitosan, salicylic acid, methyl salicylate, or sodium salicylate. In some embodiments, the composition comprises about 93% to about 97% by weight glycerol monostearate, about 1% to about 6% by weight of sodium lauryl sulfate, sodium tetradecyl sulfate, or sodium bis (2-ethyhexyl) sulfosuccinate, and about 1% to about 16% by weight of benzoate, sodium benzoate, chalcone, chitosan, salicylic acid, methyl salicylate or sodium salicylate.

In some embodiments, the composition comprises about 20 g/L to about 45 g/L of glycerol monostearate, about 0.5 g/L to about 4.5 g/L of sodium lauryl sulfate, sodium tetradecyl sulfate, or sodium bis (2-ethyhexyl) sulfosuccinate, and about 0.1 g/L to about 10 g/L of benzoate, chalcone, chitosan, salicylic acid, methyl salicylate, or sodium salicylate. In some embodiments, the composition comprises about 27.5 g/L to about 28.5 g/L of glycerol monostearate, about 1.5 g/L to about 2.1 g/L of sodium lauryl sulfate, sodium tetradecyl sulfate, or sodium bis (2-ethyhexyl) sulfosuccinate, and about 1.5 g/L to about 7.5 g/L of benzoate, chalcone, chitosan, salicylic acid, methyl salicylate, or sodium salicylate.

In some embodiments, the composition further comprises about 1% to about 50% by weight of the pH adjusting agent. In some embodiments, the composition further comprises about 1% to about 10% by weight of the pH adjusting agent. In some embodiments, the composition further comprises about 1% to about 50% by weight of citric acid. In some embodiments, the composition further comprises about 3% to about 9% by weight of citric acid.

In some embodiments, the composition further comprises about 0.1g/L to about 10 g/L of the pH adjusting agent. In some embodiments, the composition further comprises about 1 g/L to about 4 g/L of the pH adjusting agent. In some embodiments, the composition further comprises about 0.1 g/L to about 10 g/L of citric acid.

In some embodiments, the composition comprises about 63% by weight glycerol monostearate, about 4% by weight sodium lauryl sulfate, and about 33% by weight sodium benzoate. In some embodiments, the composition comprises about 9.4 g/L glycerol monostearate, 0.6 g/L sodium lauryl sulfate, and about 5 g/L sodium benzoate.

In some embodiments, the composition comprises about 72% by weight glycerol monostearate, about 15% by weight sodium benzoate, about 8% by weight citric acid, and about 5% by weight sodium lauryl sulfate. In some embodiments, the composition comprises about 23.5 g/L glycerol monostearate, about 5 g/L sodium benzoate, about 2.5 g/L citric acid, and about 1.5 g/L sodium lauryl sulfate.

In some embodiments, the composition comprises about 81% by weight glycerol monostearate, about 9% by weight sodium benzoate, about 5% by weight citric acid, and about 5% by weight sodium lauryl sulfate. In some embodiments, the composition comprises about 45 g/L glycerol monostearate, about 2 g/L sodium benzoate, about 2.5 g/L citric acid, and about 3 g/L sodium lauryl sulfate.

In some embodiments, the composition comprises about 78% by weight glycerol monostearate, about 12% by weight sodium benzoate, about 4% by weight citric acid, and about 5% by weight sodium lauryl sulfate. In some embodiments, the composition comprises about 45 g/L glycerol monostearate, about 7 g/L sodium benzoate, about 2.5 g/L citric acid, and about 3 g/L sodium lauryl sulfate.

In some embodiments, the composition comprises about 71% by weight glycerol monostearate, 18% by weight sodium benzoate, 6% by weight citric acid, and5% by weight sodium lauryl sulfate. In some embodiments, the composition comprises about 28.2 g/L glycerol monostearate, about 7 g/L sodium benzoate, about 2.5 g/L citric acid, and about 1.8 g/L sodium lauryl sulfate.

### Methods

Also provided herein are methods of improving the shelf life of produce, the method comprising coating the produce with any one of the embodiments of the composition described herein.

Also provided herein are methods of delaying the onset of microbial growth, the method comprising coating a produce with any one of the embodiments described herein.

Also provided herein is a method of preventing produce desiccation, the method comprising coating a produce with any one of the embodiments described herein. In some embodiments, desiccation is measured with mass loss. Mass loss, for example, can be measured by determining the difference between the weight of a produce directly after coating and after a certain amount of time passes. In some embodiments, mass loss is measured after 1 week, 12 weeks, or any time inbetween, or after any combination thereof.

In some embodiments, a single coating is used. In some embodiments, multiple coats are used (e.g., multiple coats of the same composition or multiple coats of different compositions). In some embodiments, coatings are dried at air temperature or are heated to dry. In some embodiments, coatings are dried in an air tunnel.

Any of the coatings described herein can be disposed on the external surface of an agricultural product or plant using any suitable means. For example, in some embodiments, the agricultural product can be dip coated in a bath of the coating (e.g., an aqueous solution of hydrogen-bonding organic molecules). The coating be an exogenous coating in the form a thin layer on the surface of agricultural product (e.g., on an exterior surface, such as a cuticular surface), which can protect the agricultural product from biotic stressors, water loss, and/or oxidation.

In some embodiments, the deposited coating has a thickness of less than about 2 microns, for example less than 1 micron, less than 500 nm, or less than 100 nm, such that the coating is transparent to the naked eye. For example, the deposited coating can have a thickness of about 50 nm, 100 nm, 250 nm, 500 nm, or about 1,000 nm inclusive of all ranges therebetween. The deposited coating can have a high degree of crystallinity to decrease permeability, such that the coating is conformally deposited over the agricultural product and is free of defects and/or pinholes. In some embodiments, the dip coating process includes sequential coating of the agricultural product in baths of precursors that can undergo self-assembly or covalent bonding on the agricultural product to form the coating. In some embodiments, the coatings are deposited on agricultural products by passing the agricultural products under a stream of the coating (e.g., a waterfall of the liquid coating). For example, the agricultural products can be disposed on a conveyor that passes through the stream of the coating. In some embodiments, the coating is vapor deposited on the surface of the agricultural product. In some embodiments, the coating is formulated to be fixed on the surface of the agricultural product by UV cross-linking or by exposure to a reactive gas, for example, oxygen. In some embodiments, the coating is applied in the field before harvest as an alternative to pesticides.

In some embodiments, any of the coatings is spray coated on the agricultural products. For example, commercially available sprayers can be used for spraying the coating or precursors of the coating onto the agricultural product. In some embodiments, the coatings are electrically charged in the sprayer before spray coating on the agricultural product, such that the coating covalently bonds to the exterior surface of the agricultural product.

In some embodiments, the coating is deposited on the agricultural product such that the coating is unbound to the surface of the agricultural product. In some embodiments, one or more components of the coating, for example, the hydrogen-bonding organic molecule, is covalently (or hydrogen) bonded to at least a portion of the surface of the agricultural product. This can result, for example, in improved coating properties such as, for example, higher durability, tighter control of coating permeability and thickness. In some embodiments, multiple layers of the coating are deposited on the surface of agricultural product to achieve a durable coating.

### EXAMPLES

The invention will be described in greater detail by way of specific examples. The following examples are offered for illustrative purposes, and to exemplify the topical compositions described herein and not intended to limit the invention in any manner. Many variations will suggest themselves and are within the full intended scope. Those of sill in the art will readily recognize a variety of non-critical parameters that can be changed or modified to yield essentially the same results.

### Example 1

### Testing Multiple Exemplary Compositions on Penicillium italicum Disease Susceptibility of Mandarin Oranges

A mixture of glyceryl monostearate, sodium benzoate, citric acid, and optionally sodium lauryl sulfate (SLS) was added to 1L of deionized distilled water in the amounts indicated in Table 1 and heated to 80° C. The composition was blended for 3 min at high speed and cooled to room temperature.

TABLE 1
Sample Compositions to Test
Susceptibility to Penicillium italicum

| | | Sodium | Citric | |
|---|---|---|---|---|
| Sample | GMS | Benzoate | Acid | SLS |
| (sample type) | (g/L) | (g/L) | (g/L) | (g/L) |
| A (control) | 9.4 | 0 | 0 | 0 |
| B | 9.4 | 2 | 0 | 0 |
| C | 9.4 | 5 | 0 | 0 |
| D | 23.5 | 5 | 2.5 | 1.5 |
| E (control) | 46 | 0 | 0 | 2 |
| F | 45 | 1 | 2.5 | 3 |
| G | 45 | 2 | 2.5 | 3 |
| H | 45 | 5 | 2.5 | 3 |
| I | 45 | 7 | 2.5 | 3 |

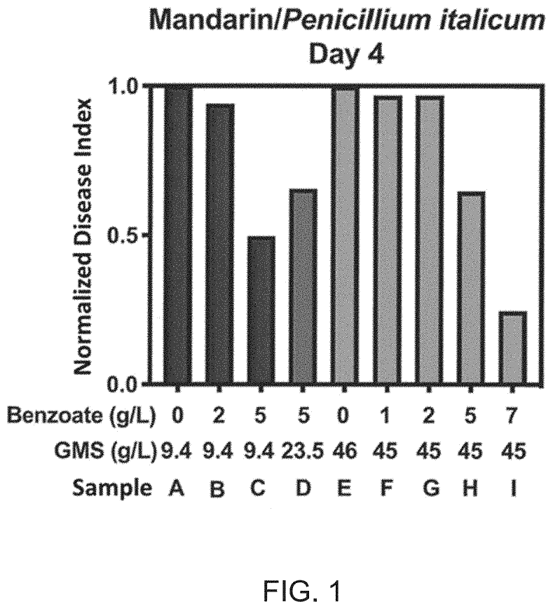

Dispersions B, C, D, F, G, H, and I were stable after being left at room temperature overnight and had a pH of 4.0-4.5. Sample A had a pH of 6.12. The samples were then used for further testing of antimicrobial properties on Mandarin oranges. Thirty mandarin oranges per sample type were tested. Oranges were treated by dipping into a bowl containing the indicated solution, ensuring that all sides were coated. The oranges were then dried on a rack with a fan. Disease indices of Penicillium italicum were measured after four days and normalized to the corresponding no sodium benzoate or citric acid with 9.4 g/L of glyceryl monostearate composition (Sample A). Disease index is on a scale from 0-1 and takes into account both the percent of fruit infected and the average severity of the infection in the sample group. The average severity is on a scale from 0-4. Disease index is calculated as follows: (Percent infected*Average infection severity)/4/100. Compositions that included at least 5 g/L of sodium benzoate showed lower disease indices than control compositions, indicating that the compositions are able to provide antimicrobial protection (FIG. 1, samples C, D, H, and I).

### Example 2

### Testing Composition on Mexican Avocados

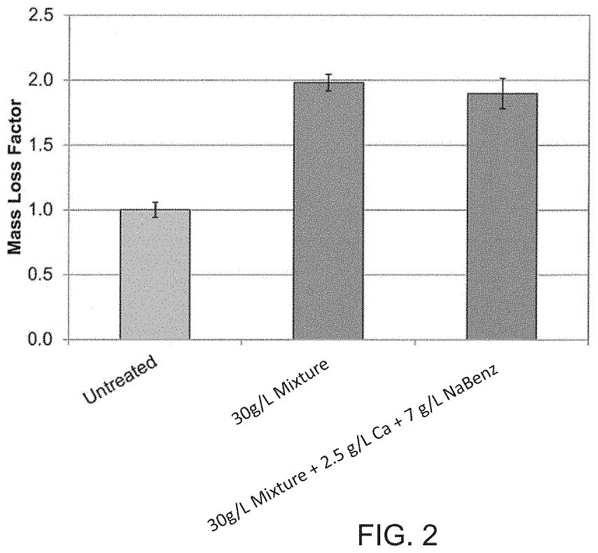

To test moisture barrier properties, Mexican avocados were treated with a mixture of 30 g/L of a 94% glycerol monostearate and 6% sodium dodecyl sulfate blend, a mixture of 30 g/L of a 94% glycerol monostearate and 6% sodium dodecyl sulfate blend, 2.5 g/L citric acid, and 7 g/L of sodium benzoate, or were left untreated. Avocados were weighted, stored in 8° C. in 80% relative humidity, and weighted over time. Mass loss factor was calculated relative to untreated avocados. Both the mixture of the glycerol monostearate and sodium dodecyl sulfate blend and sodium benzoate—containing treatments resulted in less mass loss (i.e. larger mass retention) than untreated avocados, with an insignificant difference between treatments (FIG. 2).

### Example 3

### Epicatechin, Acibenzolar-S-Methyl (ASM) and MeSA Screening For Stem End Rot (Colletotrichum) Infection Control

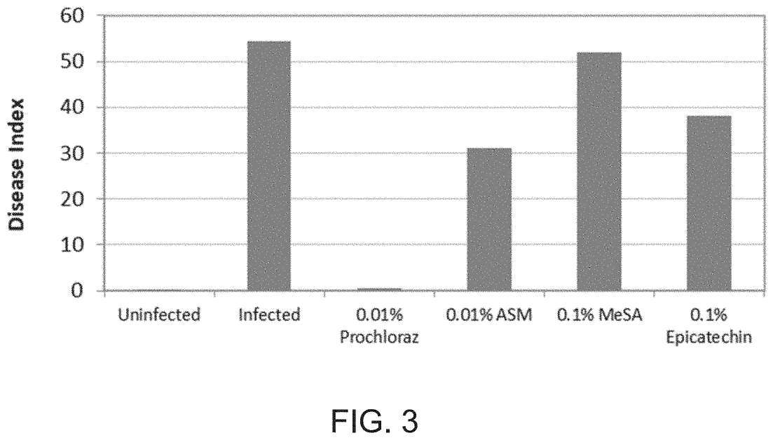

To screen for infection control of stem end rot (Colletotrichum) with epicatechin, ASM, and MeSA (methyl salicylate), California avocados size 84 were infected with Colletotrichum spores (10³ spores/ml) and treated with 0.01% an imidazole antifungal agent, such as Prochloraz, 0.1% epicatechin, 0.01% ASM, or 0.1% MeSA, as indicated. Uninfected and infected controls were not exposed to treatments. Following treatment, the percent disease index for stem end rot was observed for each avocado. Disease index is on a scale from 0-1 and takes into account both the percent of fruit infected and the average severity of the infection in the sample group. The average severity is on a scale from 0-4. Percent disease index is calculated as follows: (Percent infected*Average infection severity)/4. Prochloraz was effective at decreasing the observed disease index, and 0.01% ASM and 0.1% epicatechin treatments had significantly smaller disease indices compared to the infected control. There was no observed effect of MeSA on the disease index of infected avocados (FIG. 3).

### Example 4

### Determining Impact of Various Concentrations of Salicylic Acid, Sodium Salicylate, and Chitosan On Stem End Rot

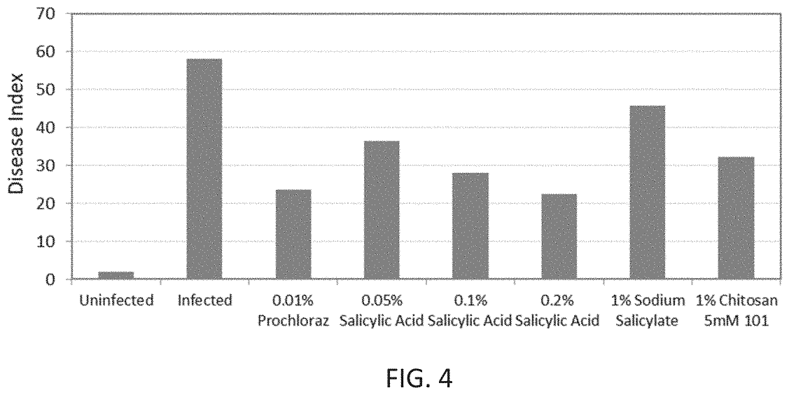

To determine the impact of salicylic acid, sodium salicylate, and chitosan on stem end rot (Colletotrichum), California avocados size 96 were infected with 10³ Colletotrichum spores and treated with 0.01% of an imidazole antifungal agent, such as Prochloraz, 0.05% salicylic acid, 0.1% salicylic acid, 0.2% salicylic acid, 1% sodium salicylate, or 1% chitosan +5 mM C10 monoglyceride. Uninfected and infected controls were not exposed to treatments. Following treatment, the percent disease index of stem end rot was determined for each avocado. Prochloraz treatment was effective at decreasing the disease index compared to the infected control. The 0.05%, 0.1%, 0.2% salicylic acid treatments and 1% chitosan +5 mM C10 monoglyceride treatments also reduced the stem end rot disease index, with the highest dose of salicylic acid (0.2%) being the most effective. However, the 1% chitosan +5 mM C10 monoglyceride treatment sample size was 14 avocados. The 1% sodium salicylate did not significantly reduce the disease index compared to the infected control sample (FIG. 4).

### Example 5

### Determining Impact of Salicylic Acid and Chitosan Combinations on Stem End Rot

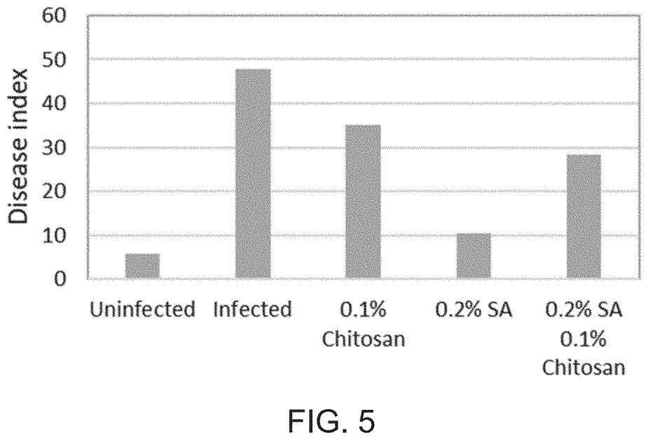

To determine the impact of salicylic acid and chitosan combinations on stem end rot (Colletotrichum), Mexican avocados size 84 were infected with 10³ Colletotrichum spores and treated with 0.01% of an imidazole antifungal agent, such as Prochloraz, 0.1% low molecular weight chitosan (1 g/L), 0.2% salicylic acid, or 0.2% salicylic acid +0.1% chitosan. Uninfected and infected controls were not exposed to treatments. Following treatment, the percent disease index of stem end rot was determined for each avocado. All treatments decreased the disease index compared to the infected control, with the 0.2% salicylic acid having the greatest effect. The combination of salicylic and chitosan did not show synergy (FIG. 5).

### Example 6

### Determining Impact of Salicylic Acid on Avocado Storage.

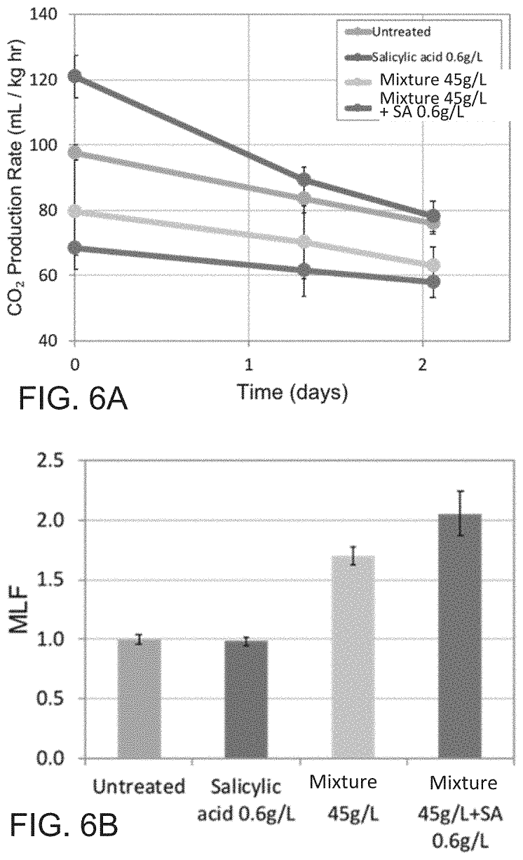

To determine the impact of salicylic acid on avocado storage, avocados previously stored for about one month were treated with 0.6 g/L salicylic acid, 45 g/L of a mixture of 94% glycerol monostearate and 6% sodium stearate, or a 0.6 g/L salicylic acid+45 g/L of a mixture of 94% glycerol monostearate and 6% sodium stearate by dipping avocados in the treatment and drying in a drying tunnel. Avocados were Mexican avocados size 60. Mixing tests determined the amount of salicylic acid that could be combined with the mixture of glycerol monostearate and sodium stearate and resulted in a solution with a pH of about 7.5. Avocados were monitored for two days for CO₂ production (respiration) rate, mass loss, incidence of stem end rot, and severity of stem end rot disease. Salicylic acid by itself increased the respiration compared to the control, but when in combination with the mixture of glycerol monostearate and sodium stearate showed a reduction compared to the mixture of glycerol monostearate and sodium stearate alone. This could be due to changes in the barrier stability or barrier properties when salicylic acid is combined with the mixture of glycerol monostearate and sodium stearate. When comparing the mass loss factor using the salicylic acid+the mixture of glycerol monostearate and sodium stearate to the mixture itself, there was a 0.35× improvement. Severity of stem end rot disease was measured on a 1-4 stem end rot severity scale (STR). The use of salicylic acid seemed to reduce the severity, not incidence, of infection (FIG. 6).

### Example 7

### Determining the Impact of Salicylic Acid and pH on Stem End Rot

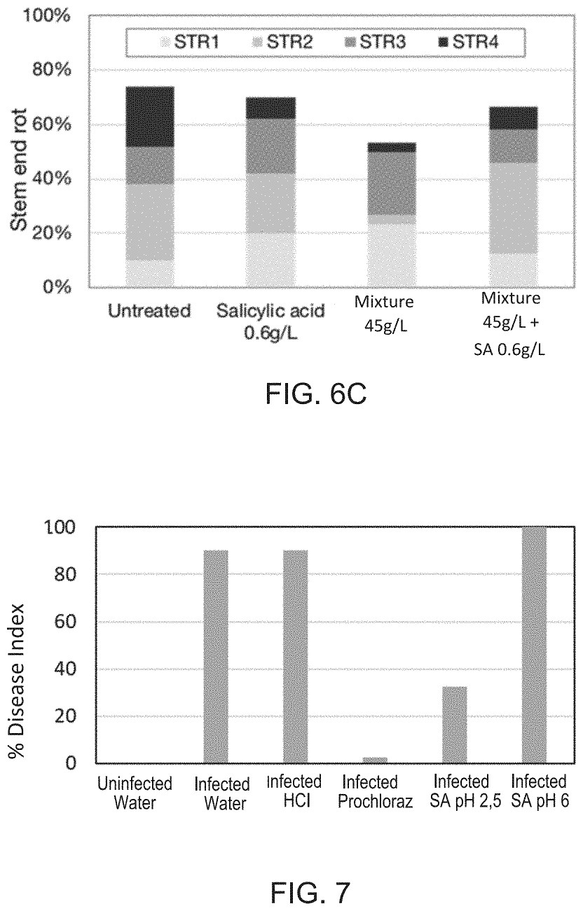

To determine the impact of salicylic acid and pH on stem end rot (Colletotrichum), Colletotrichum disease indices of avocados were determined with various treatments. Previous studies have shown that salicylic acid at pH 2.5 inhibits germination, but loses its inhibitory effect as pH is raised to pH 6, at which point germination is similar to that seen in water alone. Mexican avocados size 84 were infected with 10³ Colletotrichum spores and treated with 1 M NaOH pH 6, 0.01% of an imidazole antifungal agent, such as Prochloraz, 0.2% salicylic acid pH 2.5, or 0.2% salicylic acid pH 6. pH was adjusted with 1 M NaOH. Uninfected and infected controls were not exposed to treatments. Infection rate was near 100% for the water treated control. Treatment of infected avocados with pH 2.5. Water+HCl did not reduce infection. Treatment with salicylic acid at pH 2.5 reduced percent infection by nearly 70%. However, the percent disease index remained at 100% during treatment with salicylic acid at a pH of 6 (FIG. 7).

### Example 8

### Determining the Impact of Salicylic Acid and a Mixture of 94% Glycerol Monostearate and 6% Sodium Stearate Combinations on Avocado Storage

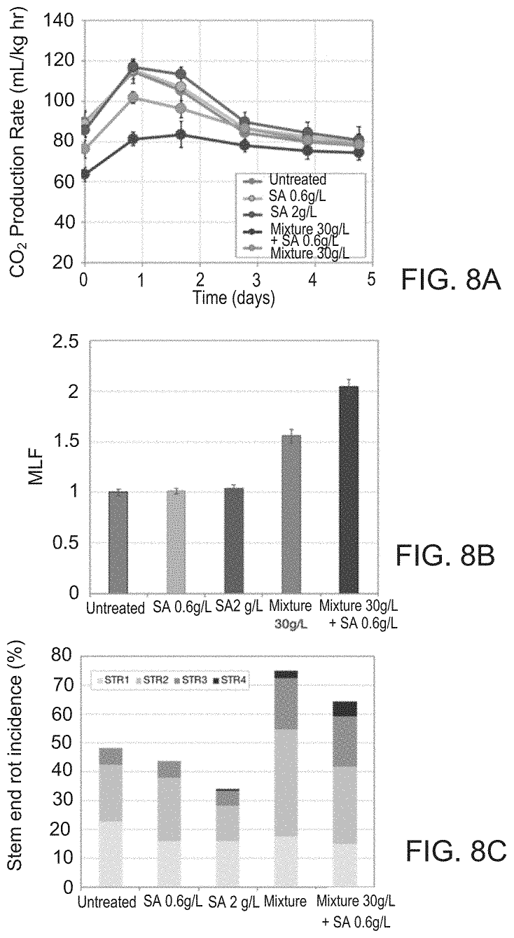

To determine the impact of salicylic acid and a mixture of 94% glycerol monostearate and a 6% fatty acid salt combinatorial treatment on avocado, Mexican avocados size 60 were exposed to 0.6 g/L salicylic acid, 2.0 g/L salicylic acid, 30 g/L a mixture of glycerol monostearate and sodium stearate, or 0.6 g/L salicylic acid+30 g/L a mixture of glycerol monostearate and sodium stearate treatments. To treat, avocados were removed form cold storage and left at room temperature for four hours. Avocados were then dipped in treatments as indicated and dried in a drying tunnel. Uninfected controls were not exposed to treatments. Avocados were monitored for five days for CO₂ production (respiration) rate, mass loss, incidence of stem end rot, and severity of stem end rot disease on a 1-4 stem end rot severity scale (STR). The experiment was concluded when untreated avocados reached a ripeness of <35 shore. Salicylic acid did not increase CO₂ production (respiration) compared to the control, but in combination with the mixture of glycerol monostearate and sodium stearate it showed a reduction compared to the mixture of glycerol monostearate and sodium stearate alone. This may be due to changes in barrier stability or properties. Salicylic acid treatment caused slight reductions in the incidence and severity of stem end rot (FIG. 8).

### Example 9

### Determining the Impact of Sequential Salicylic Acid and a Mixture of 94% Glycerol Monostearate and 6% Sodium Stearate Treatments on Stem End Rot

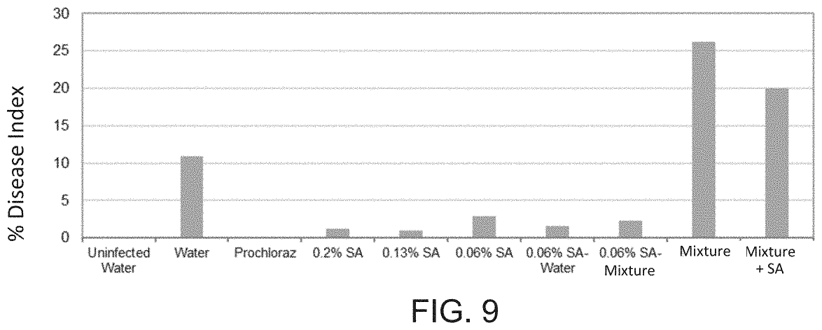

To determine the impact of sequential salicylic acid and a mixture of 94% glycerol monostearate and 6% sodium stearate treatments on stem end rot (Colletotrichum), size 84 Mexican avocados infected with 10³ Colletotrichum spores and treated with 0.01% of an imidazole antifungal agent, such as Prochloraz, 0.2% salicylic acid pH 6, 0.2% salicylic acid pH 2.3, 0.13% salicylic acid pH 2.3, 0.06% salicylic acid pH 2.3, or 30 g/L the mixture of glycerol monostearate and sodium stearate. The pH was adjusted with 1 M NaOH. Salicylic acid treatments were performed and dried before subsequent treatments with the mixture of glycerol monostearate and sodium stearate were performed for combinatorial treatments. Controls with salicylic acid treatment and a subsequent treatment with water were also performed. Uninfected controls were not exposed to treatments. Following treatment, the disease index of stem end rot was determined for each avocado. Decreasing the concentration of salicylic acid from 0.2% to 0.06% reduced the effectiveness of the treatment leading to an increase in percent disease index, but was more effective than then infected water control treatment. Using a second treatment following salicylic acid treatment reduced the percent disease indices, indicating either that the salicylic acid did not wash off in subsequent treatment or that salicylic acid had the necessary effect prior to subsequent treatment. The mixture of glycerol monostearate and sodium stearate alone, or the mixture first then salicylic acid combinatorial treatment increased percent disease indices and were not effective. Salicylic acid was effective in treatments with salicylic acid first and the mixture of glycerol monostearate and sodium stearate treatment second (FIG. 9).

### Example 10

### Determining the Impact of Salicylic Acid (SA) and a Mixture of 94% Glycerol Monostearate and 6% Sodium Stearate Combinatorial Treatments on Avocado Storage

To determine the impact of salicylic acid and a mixture of 94% glycerol monostearate and 6% sodium stearate combinatorial treatments on stem end rot (Colletotrichum), 120 Mexican avocados size 60 were treated with 1 g/L salicylic acid, 2 g/L salicylic acid, 3 g/L of salicylic acid or were treated with water. Avocados were fan dried for 1.5 hours then treated with 30 g/L the mixture of 94% glycerol monostearate and 6% sodium stearate, or left untreated. Avocados that received a second treatment were dried in a warm drying tunnel. This treatment regime resulted in a total of eight treatment groups (untreated (water), SA 1 g/L, SA 2 g/L, SA 3 g/L, 30 g/L the mixture of 94% glycerol monostearate and 6% sodium stearate, 30 g/L the mixture of 94% glycerol monostearate and 6% sodium stearate +1 g/L SA, 30 g/L the mixture of 94% glycerol monostearate and 6% sodium stearate +2 g/L SA, or 30 g/L the mixture of 94% glycerol monostearate and 6% sodium stearate +3 g/L SA. When added to the 94% glycerol monostearate and 6% sodium stearate mixture, salicylic acid improved the quality of 6% of the avocados compared to avocados treated with only the 94% glycerol monostearate and 6% sodium stearate mixture (FIG.

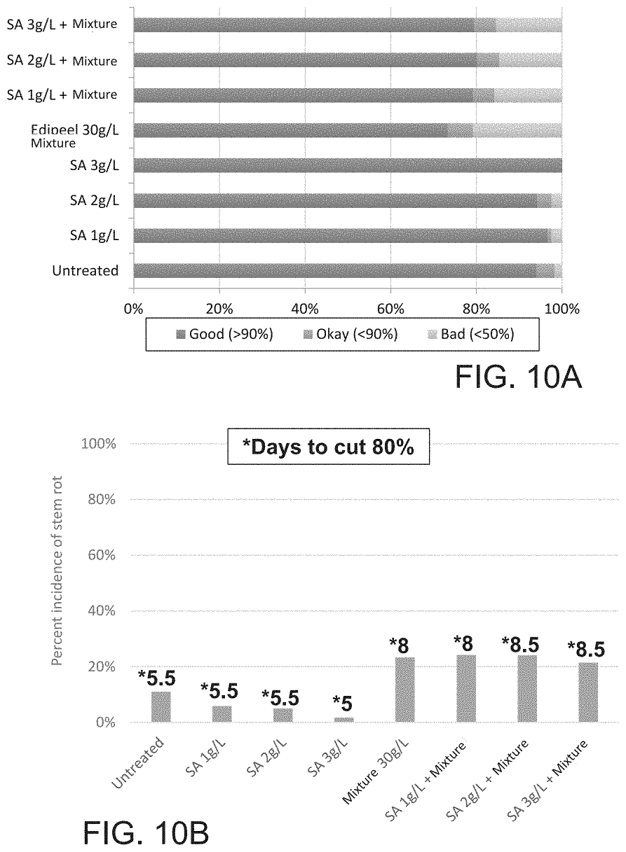

10A). Also, the addition of salicylic acid to the 94% glycerol monostearate and 6% sodium stearate mixture had no effect on mold incidence (FIG. 10B). Salicylic acid treated avocados appeared to have more shine than non-salicylic acid treated avocados.

### Example 11

### Determining the Viscosity and pH of Salicylic Acid and a Mixture of 94% Glycerol Monostearate and 6% Sodium Stearate Combinations

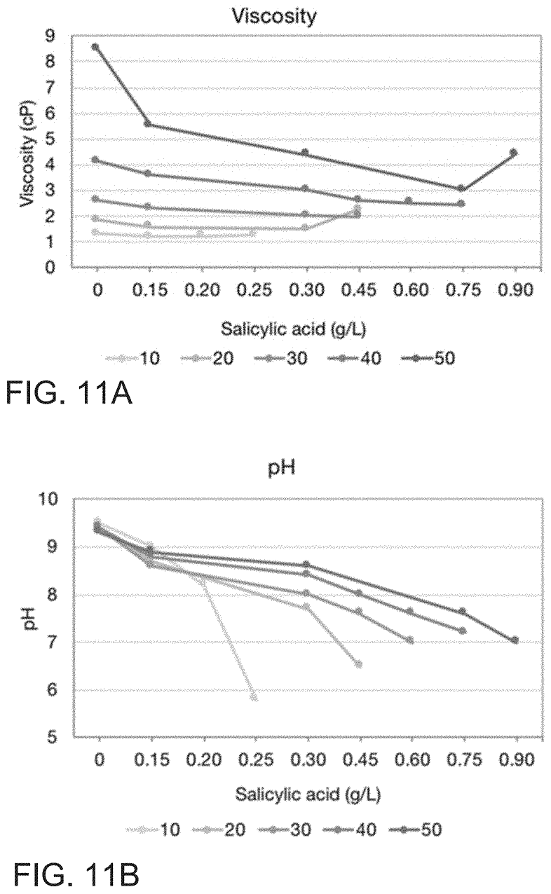

To determine the threshold of salicylic acid that can be added to a mixture of 94% glycerol monostearate and 6% sodium stearate, various combinations of salicylic acid and the mixture were made and tested for viscosity, pH, and contact angle. All combinations of 10, 20, 30, 40, and 50 g/L of the mixture were mixed with salicylic acid concentrations ranging from 0.15-1.0 g/L. The mixture of glycerol monostearate and sodium stearate and salicylic acid were mixed in a blender with water and allowed to sit for six hours before testing pH and viscosity. The viscosity decreased as the mixture concentration increased, and as the salicylic acid concentration increased (FIG. 11A). The pH in water ranged from 2-2.5, which decreased the pH when added to the mixture solutions (FIG. 11B). The maximum amount of salicylic acid that could be added was about 2% of the weight of the mixture (FIG. 10). When pH decreased below 7, the solution took on the consistency of jelly.

### Example 12

### Determining the Viscosity and pH of Methyl Salicylate and a Mixture of 94% Glycerol Monostearate and 6% Sodium Stearate Solutions

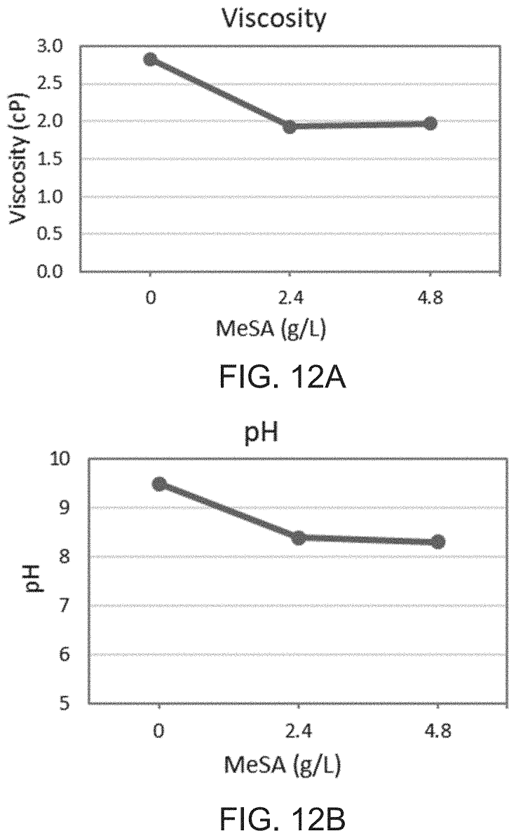

To determine the threshold of methyl salicylate that can be added to a mixture of 94% glycerol monostearate and 6% sodium stearate, solutions of methyl salicylate and the mixture were made and tested for viscosity and pH. 30 g/L of the mixture of glycerol monostearate and sodium stearate were combined with 2.4 g/L and 4.8 g/L methyl salicylate, or left mixed. The mixture of glycerol monostearate and sodium stearate and methyl salicylate were mixed in a blender with water and allowed to sit for six hours before testing pH and viscosity. Mixing methyl salicylate and the mixture of glycerol monostearate and sodium stearate is possible, with a small dose-independent decrease in viscosity of about 1 cP and pH of about 1 (FIG. 12A-B).

### Example 13

### Determining the Impact of a Mixture of 94% Glycerol Monostearate and 6% Sodium Stearate and Carvacrol on Ripening and Quality of Avocados

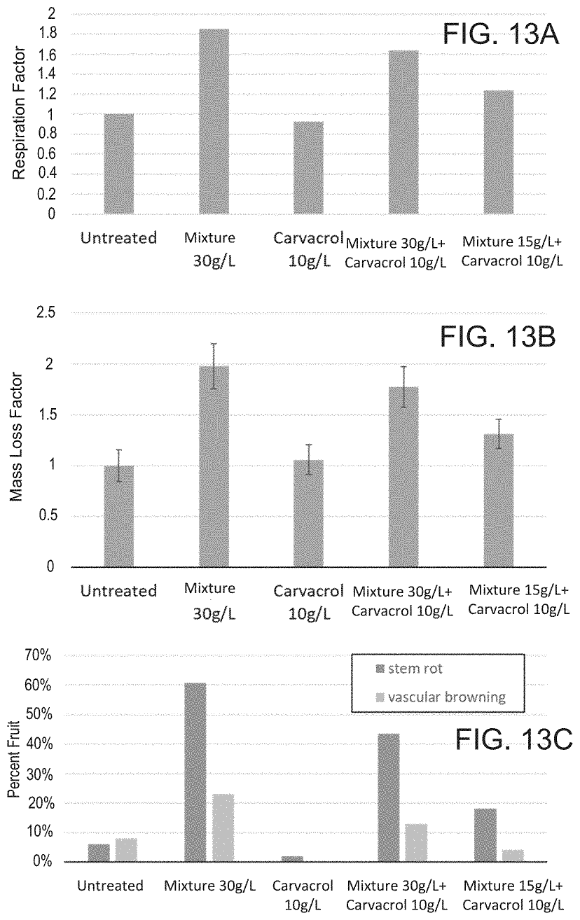

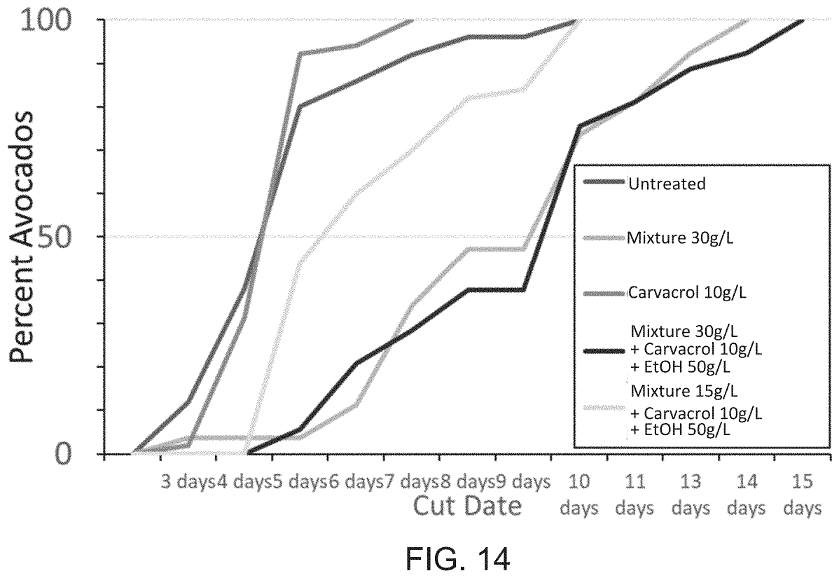

To determine the impact of a mixture of 94% glycerol monostearate and 6% sodium stearate and carvacrol on ripening and quality of avocados, California avocados sized 96 were treated with 30 g/L the mixture of glycerol monostearate and sodium stearate, 10 g/L carvacrol, 30 g/L the mixture of glycerol monostearate and sodium stearate+10 g/L carvacrol+50 g/L ethanol, or 15 g/L the mixture of glycerol monostearate and sodium stearate+10 g/L carvacrol+50 g/L ethanol. Fifty-four avocados were tested per treatment. Avocados were dipped into treatment liquids and allowed to dry. Respiration (CO₂ production), mass loss, disease indices of stem end rot and vascular browning were measured. The addition of carvacrol to the mixture of glycerol monostearate and sodium stearate reduced respiration by ˜0.2×, but carvacrol alone may have accelerated respiration, possible because of a lack of barrier properties (FIG. 13A). Carvacrol alone had a negligible effect on mass loss, but decreased mass loss when combined with the mixture of glycerol monostearate and sodium stearate compared to untreated avocados (FIG. 13B). The addition of carvacrol to 30 g/L of the mixture of glycerol monostearate and sodium stearate reduced the incidence of stem end rot by ˜20% and the incidence of vascular browning by ˜10%, and carvacrol alone almost eliminated disease incidence of vascular browning and stem end rot (FIG. 13C). The timing of spoilage was affected by treatments (FIG. 14).

### Example 14

### Determining the Impact of an Organic Mixture of Glycerol Monostearate and Sodium Stearate Mixed With Carvacrol on Mass Loss and Mold in Organic Lemons

To determine the impact of an organic mixture of glycerol monostearate and sodium stearate mixed with carvacrol on mass loss and mold incidence in organic lemons, unwaxed

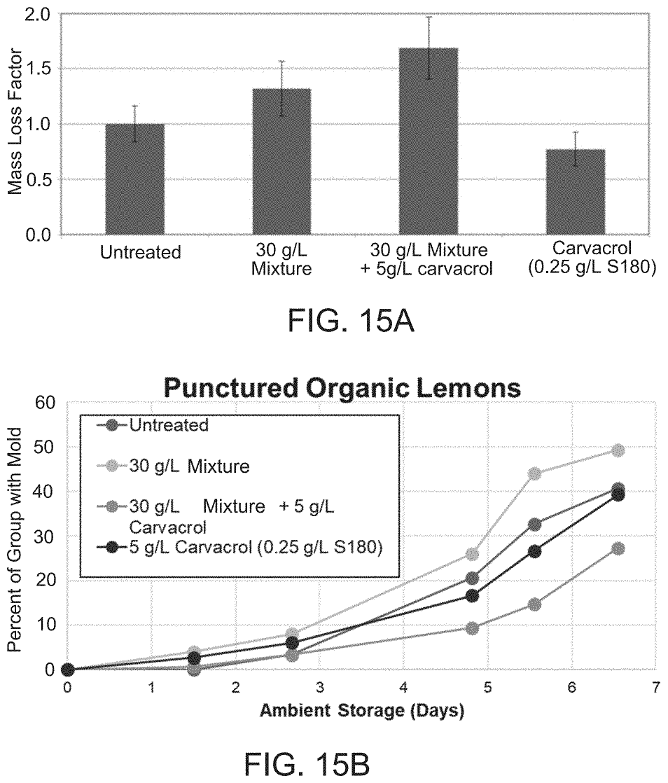

California organic lemons sized 140 were exposed to 30 g/L an organic mixture of glycerol monostearate and sodium stearate mixed, 30 g/L an organic mixture of glycerol monostearate and sodium stearate+5 g/L carvacrol, or 5 g/L carvacrol+0.25 g/L sodium stearate, or were untreated. Batches of 140 lemons per condition were used. Lemons were physically wounded with the stem of another lemon, dipped into a treatment or left untreated, and dried in ambient conditions. Mass loss and disease incidence (% of group with mold) were measured. The addition of carvacrol to an organic mixture of glycerol monostearate and sodium stearate mixed with carvacrol increased mass loss factor to 1.7× compared to the organic mixture of glycerol monostearate and sodium stearate mixed with carvacrol alone, which was 1.3× of the untreated group (FIG. 15A). The addition of carvacrol to an organic mixture of glycerol monostearate and sodium stearate mixed with carvacrol reduced the incidence of mold ˜12% from untreated lemons and 22% from an organic mixture of glycerol monostearate and sodium stearate mixed with carvacrol alone treated lemons after 6.5 days of ambient storage (FIG. 15B). It was noted that carvacrol alone damaged the lemon skin, likely leading to an increase in water loss than would have been observed.

### Example 15

### Determining the Impact of a Mixture of 94% Glycerol Monostearate and 6Sodium Stearate and Carvacrol on Mass Loss and Quality of Organic Lemons in Cold Storage

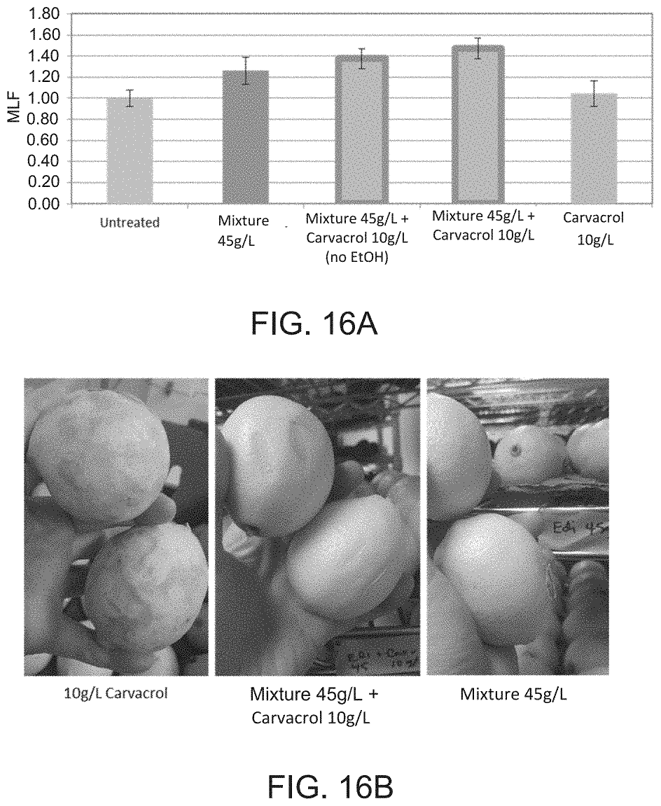

To determine the impact of a mixture of 94% glycerol monostearate and 6% sodium stearate and carvacrol on mass loss and quality of organic lemons in cold storage, bees waxed Mexican organic lemons sized 140 were exposed to 45 g/L the mixture of glycerol monostearate and sodium stearate, 45 g/L the mixture of glycerol monostearate and sodium stearate+10 g/L carvacrol, 45 g/L the mixture of glycerol monostearate and sodium stearate+10 g/L carvacrol+50 g/L ethanol, 10 g/L carvacrol+50 g/L ethanol, or were untreated. Batches of 120 lemons per condition were used. Lemons were dipped into a treatment or left untreated, dried in ambient conditions, and stored at 8° C., 80% relative humidity for several weeks. Mass loss was measured. The addition of carvacrol to the mixture of glycerol monostearate and sodium stearate without ethanol increased mass retention compared to the mixture of glycerol monostearate and sodium stearate alone, carvacrol alone, or untreated lemons (FIG. 16A). It was noted that carvacrol alone damaged the lemon skin (FIG. 16B), but that there was no residual carvacrol smell on the fruit surface after seven days, except under stickers.

### Example 16

### Determining the Impact of a Mixture of 94% Glycerol Monostearate and 6% Sodium Stearate and Carvacrol Concentrations on Mass Loss and Quality of Organic Lemons in Cold Storage

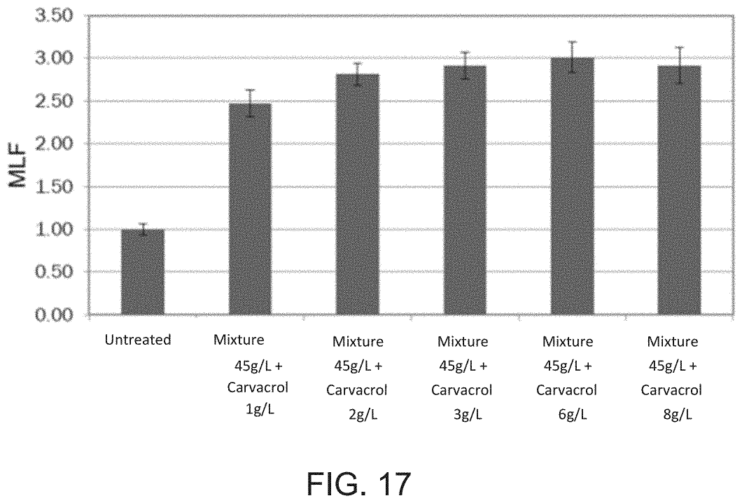

To determine the impact of a mixture of 94% glycerol monostearate and 6% sodium stearate and carvacrol concentrations on mass loss and quality of organic lemons in cold storage, bees waxed Mexican organic lemons sized 140 were exposed to 45 g/L the mixture of glycerol monostearate and sodium stearate with increasing concentration of carvacrol and increasing concentrations of ethanol, or were untreated. Specifically, 1 g/L carvacrol+5 g/L ethanol, 2 g/L carvacrol+10 g/L ethanol, 3 g/L carvacrol+15 g/L ethanol, 6 g/L carvacrol+30 g/L ethanol, or 8 g/L carvacrol+40 g/L ethanol. Batches of 120 lemons per condition were used. Lemons were dipped into a treatment or left untreated, dried in heated conditions in a drying tunnel, and stored at ambient conditions. Mass loss was measured. The addition of carvacrol to the mixture of glycerol monostearate and sodium stearate with ethanol increased mass retention compared to the mixture alone, and untreated lemons in a dose-dependent manner. However, 3 g/L, 6 g/L and 8 g/L did not appear to be significantly different from one another (FIG. 17). It was noted that heated drying in a drying tunnel prevented carvacrol lemon skin burns, and that there was no residual carvacrol smell on the fruit surface 14 hours after treatment application.

A number of embodiments of the technology have been described. Nevertheless, it will be understood that various modifications may be made without departing from the spirit and scope of the technology. Accordingly, other embodiments are within the scope of the following claims.

What is claimed is:

1. A composition comprising:
one or more saturated glycerides selected from monoglycerides and diglycerides;
one or more surfactants; and
one or more food-safe antimicrobials.

2. The composition of claim 1, wherein the composition further comprises one or more pH adjusting agents.

3. The composition of claim 2, wherein the one or more pH adjusting agents is selected from: tartaric acid, citric acid, lactic acid, maleic acid, phosphoric acid, sodium bicarbonate, or a salt thereof.

4. The composition of claim 1, wherein the pH of the composition is lower than or equal to the pKa of the food-safe antimicrobial.

5. The composition of claim 1, wherein the pH of the composition is about pH 2 to about pH 6.

6. The composition of claim 1, wherein the one or more saturated monoglycerides has between about 10 carbons and about 20 carbons, or has between about 14 carbons and about 18 carbons.

7. The composition of claim 1, wherein one of the one or more saturated monoglycerides is glyceryl monostearate.

8. The composition of claim 1, wherein the one or more surfactants are fatty acids or salts thereof.

9. The composition of claim 1, wherein the one or more food-safe antimicrobials are selected from: sodium benzoate, potassium sorbate, carvacrol, chalcone, fludioxonil, 2-hydroxychalcone, 4-hydroxychalcone, 4′-hydroxychalcone, 2,2′-dihydroxychalcone, 2,4′-dihydroxychalcone, 2′,4-dihydroxychalcone, 2′,4′-dihydroxychalcone, 2′,4,4′-trihydroxychalcone, 2′,4,4′-trihydroxychalcone Intermediate, violastyrene, obtusaquinone, apiole, piperine, celastrol, eugenol, arthonoic acid, leoidin, antimycin A, antimycin Al, diffractaic acid, ethyl orsellinate, methyl orsellinate, mycophenolic acid, ethyl dichloroorsellinate, angolensin, isocotoin, eupatoriochromene, xanthoxylin, usnic acid, aloin, ononetin, apocynin, isopomiferin, deoxysappanone B 7,4′-dimethyl ether, chrysin dimethyl ether, bergapten, gambogic acid, 2-hydroxyxanthone, isopimpinellin, xanthyletin, acetyl hymetochrome, nobiletin, hymechrome, methoxsalen, 4-methylesculetin, tangeritin, khellin, flavone, 3,4′,5,6,7-pentamethoxyflavone, deguelin(-), citropten, deoxysappanone B trimethyl ether, deoxysappanone B 7,3′-dimethyl ether, 2′,4′-dihydroxy-4-methoxychalcone, daunorubicin hydrochloride, plumbagin, menadione, thymoquinone, levomenthol, thymol, methyl trimethoxycinnamate, chavicol, cinnamylphenol, benzoate, napthoquinone, phenone, acetophenone, benzophenone, phenylacetophenone, chitosan, salicylic acid, and sodium salicylate.

10. The composition of claim 1, wherein one of the one or more food-safe antimicrobials is a benzoate salt.

11. The composition of claim 1, wherein one of the one or more food-safe antimicrobials is chalcone, chitosan, salicyclic acid, sodium salicylate, or methyl salicylate.

12. The composition of claim 1, wherein at least one of the one or more food-safe antimicrobials is a compound of Formula (I) 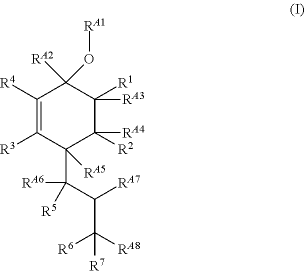
wherein:
one of the following applies:
R^{A1} and R^{A2} join to form a double bond;
R^{A3} and R^{A4} join to form a double bond;
R^{A5} and R^{A6} join to form a double bond;
and R^{A7} and R^{A8} join to form a double bond; or
(ii) R^{A1} is selected from H, C₁-C₆ alkyl, and C₁-C₆ haloalkyl;
R^{A2} and R^{A3} join to form a double bond;
R^{A4} and R^{A5} join to form a double bond;
R^{A6}, R^{A7}, and R^{A8} are independently selected from H, C₁-C₆ alkyl, and halo; or any two adjacent R^{A6}, R^{A7}, or R^{A8} join to form a double bond;
R¹, R², R³, and R⁴ are independently selected from H, C₁-C₆ alkyl, hydroxyl, halo, cyano, nitro, C₁-C₆ alkoxy, —NR′R″, —C(O)NR′R″, —C(O)C₁-C₆ alkyl, —C(O)OC₁-C₆ alkyl, C₁-C₆ haloalkoxy, and C₁-C₆ haloalkyl;
R⁵, R⁶, and R⁷ are independently selected from H, C₁-C₆ alkyl, C2-6 alkenyl, hydroxyl, halo, C₁-C₆ alkoxy, C₁-C₆ haloalkyl, 5-10 membered heteroaryl, C₆-C₁₀ aryl, C₃-C₈ cycloalkyl, 3-10 membered heterocycloalkyl, wherein the 5-10 membered heteroaryl, C₆-C₁₀ aryl, C₃-C₈ cycloalkyl, 3-10 membered heterocyclyl are optionally substituted with one or more independently selected R^{B};
or, when (i) applies, R² and R⁶ are taken together with the atoms to which they are attached to form 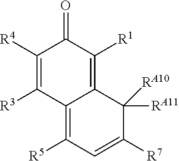
or, when (ii) applies, R^{A1} and R¹ are taken together with the atoms to which they are attached to form a 5-6 membered heterocyclyl optionally substituted with one or more independently selected R″';
or, when (ii) applies, R⁷ and R^{A8} are taken together with the atom to which they are attached to form 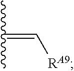
R^{A9} is selected from H or —C(O)NR′R″;
R^{A10} and R^{A11} are selected from H and C₁-C₆ alkyl,
or R^{A10} and R⁷, together with the atoms to which they are connected, join to form a C₁₄ cycloalkyl optionally substituted with one or more independently selected C₁-C₆ alkyl or C(O)OH;
each occurrence of R^{B} is independently selected from C₁-C₆ alkyl, hydroxyl, halo, cyano, nitro, C₁-C₆ alkoxy, —NR′R″, —C(O)NR′R″, —C(O)C₁-C₆ alkyl, —C(O)OC₁-C₆ alkyl, C₁-C₆ haloalkoxy, and C₁-C₆ haloalkyl;
each occurrence of R′ and R″ is independently selected from H and C₁-C₆ alkyl, or R′ and R″, together with the atom to which they are attached, join to form a 3-6 membered heterocyclyl; and
each occurrence of R″′ is independently selected from H, C₁-C₆ alkyl, C₁-C₆ haloalkyl, and halo.

13. The composition of claim 1, wherein at least one of the one or more food-safe antimicrobials is a compound of Formula (II) 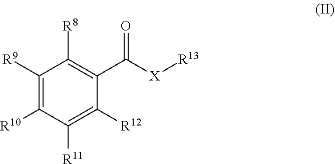
wherein:
X is selected from O and NH;
R⁸, R⁹, R¹⁰, R¹¹, and R¹² are independently selected from H, C₁-C₆ alkyl, C₂-C₆ alkenyl, C₁-C₆ alkoxy, hydroxyl, halo, -(C₁-C₆ alkyl)ₘC(O)C₁-C₆ alkyl, —NHC(O)H, —OC(O)C₆-C₁₀ aryl, wherein the C₂-C₆ alkenyl and —OC(O)C₆-C₁₀ aryl are optionally substituted with one or more independently selected R^{C};
or any two adjacent R⁸, R⁹, R¹⁰, R¹¹, and R¹² are taken together with the atoms to which they are attached to form a 5-7 membered heterocyclyl optionally fused to a C₆-C₁₀ aryl optionally substituted with one or more independently selected C₁-C₆ alkyl, halo, hydroxyl, or —C(O)OC₁-C₆ alkyl;
or R¹² and Rⁿ are taken together with the atoms to which they are attached to form a 5-6 membered heterocyclyl;
R¹³ is selected from C₁-C₆ alkyl, C₆-C₁₀ aryl, 5-9 membered heterocyclyl, wherein the C₆-C₁₀ aryl and 5-9 membered heterocyclyl are optionally substituted with one or more independently selected R^{D};
each occurrence of R^{C} is independently selected from C₁-C₆ alkyl, C₁-C₆ alkoxy, and —C(O)OH;
each occurrence of R^{D} is independently selected from C₁-C₆ alkyl, C₁-C₆ alkoxy, oxo, —C(O)OH, -(C₁-C₆ alkyl)ₘC(O)C₁-C₆ alkyl, and —OC(O)C₁-C₆ alkyl; and
m is 0 or 1.

14. The composition of claim 1, wherein at least one of the one or more food-safe antimicrobials is a compound of Formula (III) 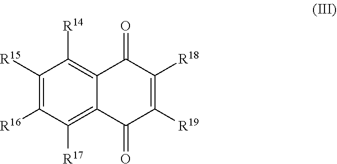
wherein:
R¹⁴, R¹⁵, R¹⁶, R¹⁷, R¹⁸ and R¹⁹ are independently selected from H, C₁-C₆ alkyl, C₁-C₆ alkoxy, hydroxyl, and halo;
or R¹⁸ and R¹⁹ are taken together with the atoms to which they are attached to form 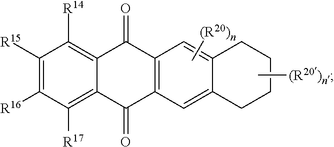
R²⁰ and R^{20′} are independently selected from hydroxyl, C₁-C₆ alkyl, halo, —C(O)C₁-C₆ alkyl, and —O—(3-8 membered heterocyclyl) optionally substituted with one or more independently selected hydroxyl, C₁-C₆ alkyl, or amino;
n is 0, 1, or 2; and
n′ is 0, 1, 2, or 3.

15. The composition of claim 1, wherein at least one of the one or more food-safe antimicrobials is a compound of Formula (IV) 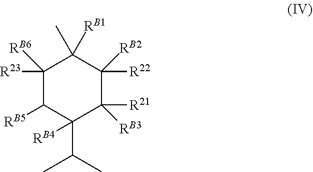
wherein:
one of the following applies:
three adjacent pairs of R^{B1}, R^{B2}, R^{B3}, R^{B4}, R^{B5}, and R^{B6} join together to form double bonds;
(ii) R^{B1} and R^{B2} join to form a double bond;
R^{B4} and R^{B5} join to form a double bond;
R²¹ and R^{B3} join to form an oxo; and
R²³ and R^{B6} join to form an oxo; or
(iii) R^{B1}, R^{B2}, R^{B3}, R^{B4}, R^{B5}, and R^{B6} are each H;
when (i) or (iii) applies, R²¹, R²², and R²³ are independently selected from H, C₁-C₆ alkyl, C₁-C₆ alkoxy, and hydroxyl; and
when (ii) applies, R²² is selected from H, C₁-C₆ alkyl, C₁-C₆ alkoxy, and hydroxyl.

16. The composition of claim 1, wherein at least one of the one or more food-safe antimicrobials is a compound of Formula (V) wherein: 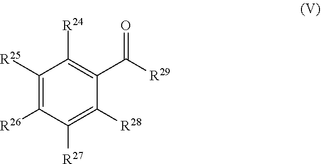
R²⁴, R²⁵, R²⁶, R²⁷, and R²⁸ are independently selected from H, C₁-C₆ alkyl, C₁-C₆ alkoxy, and hydroxyl;
or any two adjacent R²⁴, R²⁵, R²⁶, R²⁷, and R²⁸ taken together with the atoms to which they are attached form a 5-9 membered heterocycloalkenyl optionally substituted with one or more independently selected C₁-C₆ alkyl, oxo, and —C(O)C₁-C₆ alkyl;
R²⁹ is selected from C₁-C₆ alkyl and -(C₁-C₆ alkyl)ₚC₆-C₁₀ aryl, wherein the -(C₁-C₆ alkyl)ₚC₆-C₁₀ aryl is optionally substituted with C₁-C₆ alkoxy;
or R²⁸ and R²⁹ taken together with the atoms to which they are attached form 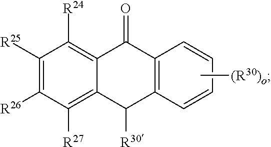
each occurrence of R³⁰ and R^{30′} is independently selected from H, C₁-C₆ alkyl optionally substituted with hydroxyl, hydroxyl, and 5-6 membered heterocyclyl optionally substituted with one or more independently selected hydroxyl or hydroxymethyl;
o is 0, 1, or 2; and
p is 0 or 1.

17. The composition of claim 1, wherein at least one of the one or more food-safe antimicrobials is a compound of Formula (VI) 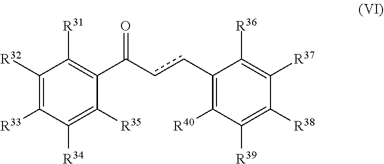
wherein: [symbol]
is a single or double bond;
R³¹, R³², R³³, R³⁴, R³⁵, R³⁶, R³⁷, R³⁸, R³⁹, and R⁴⁰ are independently selected from H, C₁-C₆ alkyl, C₁-C₆ alkoxy, halo, and hydroxyl.

18. The composition of claim 1, wherein at least one of the one or more food-safe antimicrobials is a compound of Formula (VII) 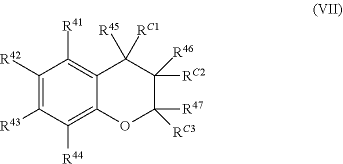
wherein:
one of the following applies:
R^{C1} and R⁴⁵ join to form an oxo; and
R^{C2} and R^{C3} are each H, or R^{C2} and R^{C3} join to form a double bond; or
(ii) R^{C3} and R⁴⁷ join to form an oxo; and
R^{C1} and R^{C2} are each H, or R^{C2} and R^{C3} join to form a double bond;
R⁴¹, R⁴², R⁴³, R⁴⁴, R⁴⁵, R⁴⁶, and R⁴⁷ are independently selected from H, C₁-C₆ alkyl, C₂-C₆ alkenyl, C₁-C₆ alkoxy, hydroxyl, —OC(O)C₁-C₆ alkyl, and -(C₁-C₆ alkyl)_{q}C₆-C₁₀ aryl optionally substituted with one or more independently selected C₁-C₆ alkyl, C₁-C₆ alkoxy, or hydroxyl;
or one or more pairs of adjacent R⁴¹, R⁴², R⁴³, R⁴⁴, R⁴⁵, R⁴⁶, and R⁴⁷ taken together with the atoms they are attached to form one or more independently selected 5-6 membered heterocyclyl, 5-6 membered heterocycloalkenyl, C₆-C₁₀ aryl, or 5-10 membered heteroaryl, wherein the 5-6 membered heterocyclyl, 5-6 membered heterocycloalkenyl, C₆-C₁₀ aryl, and 5-10 membered heteroaryl are optionally substituted with one or more independently selected C₁-C₆ alkyl, C₁-C₆ alkoxy, or hydroxyl;
or, when (i) applies, R^{C2}, R^{C3}, R⁴⁶, and R⁴⁷ taken together with the atoms they are attached to form 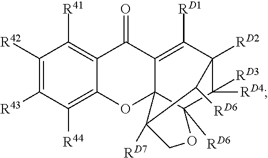
R^{D1}, R^{D2}, R^{D3}, R^{D4}, R^{D5}, R^{D6}, and R^{D7} are independently selected from H, C₁-C₆ alkyl, C₂-C₆ alkenyl optionally substituted with —C(O)OH, C₁-C₆ alkoxy, and hydroxyl,
or R^{D3} and R^{D4} join to form an oxo; and
q is 0 or 1.

19. The composition of claim 1, wherein at least one of the one or more food-safe antimicrobials is a compound of Formula (VIII) 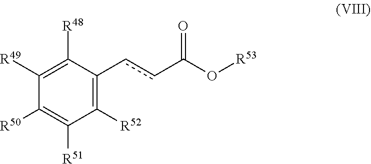
wherein: [symbol]
is a single or double bond;
R⁴⁸, R⁴⁹, R⁵⁰, R⁵¹ and R⁵² are independently selected from H, C₁-C₆ alkyl, C₁-C₆ alkoxy, halo, and hydroxyl; and
R⁵³ is selected from H, C₁-C₆ alkyl, and C₁-C₆ haloalkyl.

20. The composition of claim 1, wherein the composition comprises about 50% by weight to about 99% by weight of the one or more saturated glycerides.

21. The composition of claim 1, wherein the composition comprises about 1% by weight to about 10% by weight of the one or more surfactants.

22. The composition of claim 1, wherein the composition comprises about 1% by weight to about 50% by weight of the one or more antimicrobials.

23. A method of improving the shelf life of an agricultural product, the method comprising:
coating the agricultural product with a composition, wherein the composition comprises:
one or more saturated glycerides selected from monoglycerides and diglycerides;
one or more surfactants; and
one or more food-safe antimicrobials.

24. The method of claim 23, wherein one of the one or more food-safe antimicrobials is a benzoate salt.

25. The method of claims 23, wherein one of the one or more food-safe antimicrobials is chalcone, chitosan, salicyclic acid, sodium salicylate, or methyl salicylate.

26. The method of claim 23, wherein one or all of the one or more saturated monoglycerides has between about 10 carbons and about 20 carbons, or has between about 14 carbons and about 18 carbons

27. The method of claim 23, wherein one of the one or more saturated monoglycerides is glyceryl monostearate.

28. The method of claim 23, wherein the composition further comprises one or more pH adjusting agents.

29. A coated agricultural product comprising:
an agricultural product; and
an exogenous coating on a surface of the agricultural product, wherein the coating is formed from a composition comprising:
one or more saturated glycerides selected from monoglycerides and diglycerides;
one or more surfactants; and
one or more food-safe antimicrobials.

30. The coated agricultural product of claim 29, wherein one of the one or more food-safe antimicrobials is a benzoate salt.

31. The coated agricultural product of claim 29, wherein one of the one or more food-safe antimicrobials is chalcone, chitosan, salicyclic acid, sodium salicylate, or methyl salicylate.

32. The coated agricultural product of claim 29, wherein the one or more saturated monoglycerides has between about 10 carbons and about 20 carbons, or has between about 14 carbons and about 18 carbons.

33. The coated agricultural product of claim 29, wherein one of the one or more saturated monoglycerides is glyceryl monostearate.

34. The coated agricultural product of claim 29, wherein the composition further comprises one or more pH adjusting agents.
